(19) United States
(12) Patent Application Publication
(10) Pub. No.: US 2004/0019515 A1
(43) Pub. Date: Jan. 29, 2004

(54) Transportation infrastructure management system and method

(76) Inventor: Serdar Senyurt, Leesburg, VA (US)

Correspondence Address: NIXON PEABODY, LLP, 401 9TH STREET, NW, SUITE 900, WASINGTON, DC, 20004-2128, US

(21) Appl. No.: 10/409,617

(22) Filed: Apr. 9, 2003

Related U.S. Application Data
(60) Provisional application No. 60/370,726, filed on Apr. 9, 2002.

(51) Int. Cl. G06F 17/60

(52) U.S. Cl. 705/9

(57) ABSTRACT

A transportation infrastructure management method and system for managing service of transportation infrastructure having a plurality of transportation devices including a database adapted to store data associated with the plurality of transportation devices, the data including work orders data with service information regarding the plurality of transportation devices, and location data with information identifying locations of the plurality of transportation devices. The transportation infrastructure management system also includes a processor connected to the database and adapted to facilitate input of the data into the database and retrieval of the data from the database, and a module connected to the processor and adapted to retrieve the data associated with the plurality of transportation devices from the database based on at least one of the work orders data and the location data.

This application claims priority to U.S. Provisional Application No. 60/370,726 filed Apr. 9, 2002.

### BACKGROUND OF THE INVENTION

1. Field of the Invention

The present invention is directed to a system and method for managing public works projects, such as managing transportation infrastructure.

2. Description of Related Art

Servicing and maintenance of transportation infrastructure such as traffic signal lights are typically completed by government agencies and/or service contractors. Due to the large number of traffic signal lights that need to be managed, databases are used in attempting to keep various records regarding the traffic signal lights. Most government agency and service contractor databases are composed of fragmented systems that are connected in some parts and not in others. Client or vendor repair and maintenance work order generation, dispatch documentation and work scheduling, related follow-up activity documentation and report histories are available as individual separate components. Even when these databases are combined, their capabilities are very limited and are typically unsuited to meet the information and service needs of municipalities and government organizations.

U.S. Pat. No. 5,063,505 to Pate et al. discloses a computer implemented management system for public utilities that allows analysis of a service area by accessing a database having location information. The reference discloses that the location information may be displayed on a map and the management system is also adapted to generate reports. However, the management system is for analyzing wastewater and the information stored in the management system is related to pipe and manholes as well as other pipe system parameters. The reference fails to disclose a management system for transportation systems.

U.S. Pat. No. 5,826,252 to Wolters, Jr. et al. discloses a system for managing multiple projects using a dynamically updated project management database. The reference discloses that the system may be remotely accessed from a local site by a customer. The reference discloses that the system maintains best current lists of plans, inputs, documents, and practice success factors which are loaded into the localized computer terminals. However, the reference fails to disclose a management system having a combination of features for public works projects, in particular, transportation systems.

Other known somewhat related art include software offered by software developer Carte-graph™ that allows up-loaded and retrievable photographic records. However, the interface is not user friendly and information provided thereby is very limited. Inventory management systems and software that provide real-time storage and usage tracking are generally tailored for use with manufacturing systems and not very useful for managing transportation infrastructure. In addition, generic database software such as Microsoft Access™ only provide very limited features and usability for efficient management of transportation infrastructure.

Therefore, there still exists an unfulfilled need for a system and method for managing transportation infrastructure that will allow effective management of transportation infrastructure such as traffic signal lights and the like.

These and other advantages and features of the present invention will become more apparent from the following detailed description of the preferred embodiments of the present invention when viewed in conjunction with the accompanying drawings.

### SUMMARY OF THE INVENTION

In view of the above, one advantage of the present invention is providing a transportation infrastructure and management system that allows effective management of transportation infrastructure.

Another advantage of the transportation infrastructure and management system of the present invention is in providing easy monitoring, tracking, and scheduling of services for transportation infrastructure.

Still another advantage of the present invention is in providing such a transportation infrastructure and management system having reporting and inventorying features.

Yet another advantage of the present invention is providing such a transportation infrastructure and management system that maintains a historical database of information associated with the management of transportation devices.

These and other advantages and features are obtained by a transportation infrastructure management system for managing service of transportation infrastructure having a plurality of transportation devices comprising a database adapted to store data associated with the plurality of transportation devices, the data including work orders data with service information regarding the plurality of transportation devices, and location data with information identifying locations of the plurality of transportation devices. The transportation infrastructure management system also includes a processor connected to the database and adapted to facilitate input of the data into the database and retrieval of the data from the database, and a module connected to the processor and adapted to retrieve the data associated with the plurality of transportation devices from the database based on at least one of the work orders data and the location data.

The module of the transportation infrastructure management system in accordance with one embodiment of the present invention is a monitoring module adapted to generate a classified listing of the plurality of work orders based on the status of each of the plurality of work orders where the plurality of work orders are classified as being at least one of active, open, and complete.

The module of the transportation infrastructure management system in accordance with another embodiment of the present invention is a work order module adapted to generate a classified listing of the plurality of work orders, the plurality of work orders being classified based on parties that generated each of the plurality of work orders. The work order module may be further adapted to allow viewing of awaiting work orders which are awaiting further action by a third party. The work order module may further be adapted to allow creation of new work orders and/or editing of existing work orders.

In accordance with another embodiment, the transportation infrastructure management system may further comprise a navigation module adapted to generate a classified listing of the plurality of work orders, the plurality of work orders being classified by type of service required and/or type of transportation device. The type of service required may be group relamping and/or preventive maintenance, and the type of transportation device may be school flashers and/or fiber optic signals.

In accordance with another embodiment, the transportation infrastructure management system further includes a power module adapted to provide information regarding scheduled power outages, the information regarding scheduled power outages includes identification of locations affected.

In accordance still another embodiment, the transportation infrastructure management system may further include a location identification module adapted to search the database based on the location data identifying locations of the plurality of transportation devices. In this regard, each location may be associated with an intersection identification number to facilitate searching.

In accordance with still other embodiments of the present invention, the transportation infrastructure management system may also include an administration module adapted to allow viewing of dispatch information. In accordance with another embodiment of the present invention, the transportation infrastructure management system may also be provided with an activity module adapted to facilitate monitoring of activities being undertaken by work crews.

In yet another embodiment, the transportation infrastructure management system may further include a reporting module adapted to generate at least one report with detailed information associated with the plurality of transportation devices. The reporting module may further be adapted to generate a report based on type of service required by the plurality of transportation devices, dates of the work orders, and/or locations of the plurality of transportation devices.

In accordance with still another embodiment of the present invention, the transportation infrastructure management system may further be provided with an inventory module adapted to generate inventory information associated with the plurality of transportation devices. In this regard, each location may be associated with an intersection identification number, and the inventory module may be further adapted to search the database based on a selected intersection identification number, and generate inventory information associated with the selected intersection identification number. The inventory information may include a listing of components of transportation devices at a specific intersection location.

In the above regard, the transportation devices may be traffic signal lights, flashing signals, lane signals, pedestrian signals, street lamps, signage lamps, and/or fiber optic signals. In addition, the transportation infrastructure management system may be connected to a wide area network so that it is remotely accessible. In this regard, the wide area network may be the Internet and the transportation infrastructure management system be implemented as a website.

In accordance with another aspect of the present invention, a method of managing transportation infrastructure having a plurality of transportation devices is provided, the method comprising the steps of storing data associated with the plurality of transportation devices into a database, the data including work orders data with service information regarding the plurality of transportation devices, and location data with information identifying locations of the plurality of transportation devices, searching the data associated with the plurality of transportation devices from the database based on at least one of the work orders data and the location data, and generating a classified listing of the plurality of work orders.

In accordance with one embodiment, the classified listing may be generated based on status of each of the plurality of work orders, and the plurality of work orders may be classified as being active, open, or complete. In another embodiment, the classified listing may be generated based on parties that generated each of the plurality of work orders, and may further include the step of generating a listing of awaiting work orders which are awaiting further action by a third party. Moreover, the method may further include the step of creating new work orders and/or editing existing work orders.

In one embodiment, the classified listing may be generated based on the type of service required and/or the type of transportation device. The type of service required may be group relamping and/or preventive maintenance while the type of transportation device may be school flashers and/or fiber optic signals.

In accordance with another embodiment, the method of the present invention may further include the step of accessing information regarding scheduled power outages, where the information regarding scheduled power outages includes identification of locations affected.

In accordance with still another embodiment, the method of the present invention may further include the step of searching the database based on the location data identifying the location of the plurality of transportation devices. In this regard, each location may be associated with an intersection identification number.

In other variations of the present invention, the method may further include the step of generating dispatch information and/or generating at least one report with detailed information associated with the plurality of transportation devices. This may further include the step of generating reports based on the type of service required by the plurality of transportation devices, dates of the work orders, and locations of the plurality of transportation devices.

In accordance with yet other embodiments of the present invention, the method may further include the step of generating inventory information associated with the plurality of transportation devices. In this regard, each location may be associated with an intersection identification number, and the method may further includes the steps of searching the database based on a selected intersection identification number, and generating inventory information associated with the selected intersection identification number, the inventory information including a list of components of transportation devices at a specific intersection location. The method may also further include the step of listing activities being undertaken by work crews in still another embodiment.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a transportation infrastructure management system in accordance with one embodiment of the present invention.

FIG. 2 shows a diagram exemplifying one use of the transportation infrastructure management system of the present invention.

FIG. 3 shows a website implementation of the transportation infrastructure management system in accordance with one embodiment.

FIG. 4 shows a main page of the website implementation of the transportation infrastructure management system.

FIG. 5A shows the Monitors dropdown menu that allows access to the functions and features of the monitoring module of the transportation infrastructure management system.

FIG. 5B shows a listing of all work orders.

FIG. 5C shows a listing of open work orders.

FIG. 5D shows a listing of completed work orders.

FIG. 6A shows the View Work Orders dropdown menu that is used to access the functions and features of the work order module of the transportation infrastructure management system.

FIG. 6B shows a listing of all works orders.

FIG. 6C shows a listing of Department of Public Works work orders.

FIG. 6D shows a listing of EMA work orders.

FIG. 6E shows a listing of awaiting work orders.

FIG. 6F shows a listing of Department of Public Works internal records.

FIG. 7A shows the Navigate dropdown menu that may be used to access the functions and features of the navigation module.

FIG. 7B shows a sample DPW internal record.

FIG. 7C shows a sample group relamping screen.

FIG. 7D shows a sample preventive maintenance screen.

FIG. 7E shows a listing of surveyed field conditions.

FIG. 7F shows a sample trouble calls screen.

FIG. 7G shows a sample trouble calls screen which may be used to modify records.

FIG. 7H shows a trouble calls results screen that identifies trouble calls associated with a particular intersection or location.

FIG. 7I shows a trouble calls search screen.

FIG. 8A shows the Power Outages dropdown menu that may be used to access the functions and features of the power outages module of the transportation infrastructure management system.

FIG. 8B shows a power outages screen indicating the scheduled power outages and the affected locations.

FIG. 9A shows a searchable location identification screen for locating and identifying a particular intersection or location of interest that is used to access the functions and features of the location identification module of the transportation infrastructure management system.

FIG. 9B shows how the location identification screen of FIG. 9A may be used to identify the desired intersection or location.

FIG. 10A shows an administration main screen that may be used to access the features and functions of the administration module of the transportation infrastructure management system.

FIG. 10B shows various dropdown menus of the administration main screen.

FIG. 10C shows the record modifications screen that lists changes that have been made to each record in the transportation infrastructure management system.

FIG. 11A shows the Create Reports dropdown menu that may be used to access the functions and features of the reporting module of the transportation infrastructure management system.

FIG. 11B shows a sample report of daily activities.

FIG. 11C shows the results of a report generated using the searching feature.

FIG. 12A shows a listing of intersection locations that allows access of functions and features of the inventory module of the transportation infrastructure management system.

FIG. 12B shows a sample intersection inventory screen that sets forth detailed listings of transportation devices at an intersection or location.

FIG. 12C shows the intersection inventory screen of FIG. 12B when one of the poles is selected.

FIG. 12D shows a window with a picture of the select pole.

FIG. 13A shows the TSG Activities dropdown menu that may be used to access the functions and features of the activities module of the transportation infrastructure management system.

FIG. 13B shows a sample listing of trouble calls being addressed.

FIG. 13C shows a sample crew view screen that identifies various work crews and the work orders assigned thereto.

FIG. 14A shows another website implementation of the transportation infrastructure management system in accordance with another embodiment.

FIG. 14B shows a main page of the website implementation of the transportation infrastructure management system of FIG. 14A.

FIG. 15A shows the main page of FIG. 14B with the Monitors dropdown menu in expanded form.

FIG. 15B shows a performance statistics screen that is displayed upon selection of “Performance Monitor” from the Monitors dropdown menu.

FIG. 16A shows the main page of FIG. 14B with the TSG Activities dropdown menu in expanded form.

FIG. 16B shows a date selector and a record entry form in accordance with one implementation.

FIG. 16C shows a work order screen in accordance with one implementation.

FIG. 16D shows a payroll crew list screen in accordance with one embodiment.

FIG. 17 shows an expanded view of the Tools dropdown menu in accordance with one implementation.

FIG. 18A shows still another example of a TIMS interface in accordance with the present invention implemented as yet another website.

FIG. 18B shows a pop-up window which sets forth various details and status of recent work orders that is displayed upon logging into the website of FIG. 18A.

FIG. 18C shows the main page of the website implementation of the transportation infrastructure management system of FIG. 18A with the Inventory dropdown menu in expanded form.

FIG. 18D shows an inventory selection screen in accordance with one implementation.

FIG. 18E shows an inventory screen that is displayed upon selection of a component from the inventory selection screen of FIG. 18D.

FIG. 18F shows an inventory item search screen in accordance with one implementation.

### DETAILED DESCRIPTION OF THE PREFERRED EMBODIMENT

As will be evident from the discussion below, the present invention provides an effective system and method for managing devices of a transportation infrastructure. In particular, the transportation infrastructure management system of the present invention that allows effective management of transportation infrastructure devices such as traffic signal lights, flashing signals, lane signals, pedestrian signals, street lamps, signage lamps, fiber optic signals, etc. which are collectively referred to herein as “transportation devices”.

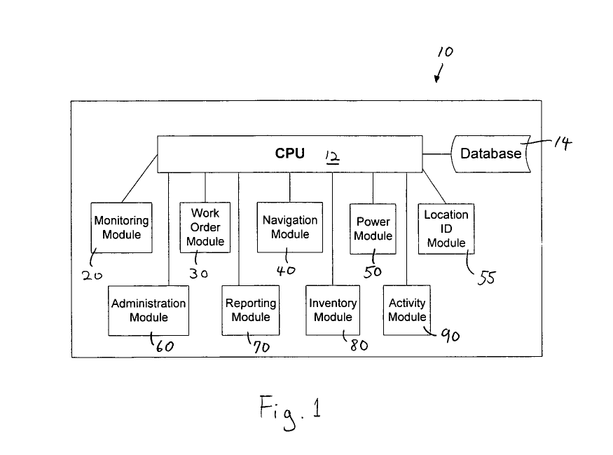

FIG. 1 shows a schematic illustration of a transportation infrastructure management system 10 (herein after “TIMS”) in accordance with one embodiment of the present invention which may be used for managing transportation devices. In accordance with the illustrated embodiment, the transportation infrastructure management system 10 is provided with a central processing unit 12 (hereinafter “CPU”) which is adapted to control and/or facilitate functions of various modules of TIMS 10 as described in further detail below.

It should be initially noted that TIMS 10 of FIG. 1 may be implemented utilizing any appropriate hardware and/or software, and may be a preprogrammed general purpose computing device. For instance, TIMS 10 may be implemented using a personal computer, a portable computer, a thin client, a handheld device, a wireless device, or any combination thereof Moreover, whereas TIMS 10 is represented as a single device at a single location in FIG. 1, it may alternatively be implemented as multiple devices at a single, or multiple, locations that are interconnected by any appropriate communication protocols over a communications medium such as electric cable, fiber optic cable, or in a wireless manner using radiofrequency, infrared, or other wireless technologies.

As shown, TIMS 10 also includes database 14 which is electronically connected to the CPU adapted to allow storage and retrieval of data and information associated with a plurality of transportation devices such as traffic signal lights, flashing signals, lane signals, pedestrian signals, street lamps, signage lamps, fiber optic signals, etc. The database 14 may be implemented in any appropriate manner, for example, as a SQL implemented database.

As also shown in FIG. 1, TIMS 10 in accordance with the illustrated embodiment is provided with a plurality of modules, each module being adapted to provide particular features and functions that enhance the utility of TIMS 10. As shown, TIMS 10 as implemented in the embodiment of FIG. 1 is provided with a monitoring module 20, a work order module 30, a navigator module 40, a power outage module 46, a preventive maintenance module 50, a location identification module 55, an administrative module 60, a reporting module 70, an inventory module 80, and an activity module 90. The specific functions and features of each of these modules are described in further detail below.

It should initially be understood that TIMS 10 as described below is provided with all of the above noted modules so that features and functions of each module can be described in detail. However, TIMS may be implemented in other embodiments with one or more of the modules noted and provision of all of the modules is not required to practice the present invention.

It is also noted that the modules above are merely schematically illustrated in FIG. 1 based on their respective functions for clarity purposes only, and do not necessarily represent specific hardware or software. In this regard, these modules may be hardware and/or software implemented to substantially provide the particular features and functions explained below. Of course, it should be evident to one of ordinary skill in the art that two or more of these modules may be combined together, or alternatively, be subdivided into additional modules in other implementations of the present invention. Furthermore, two or more of these modules may be interlinked together so that features provided by one module may be accessed while utilizing a different module. In addition, in the embodiment where the present invention is implemented in software form, TIMS 10 may be embodied as a single executable file and data files, or plurality of such files.

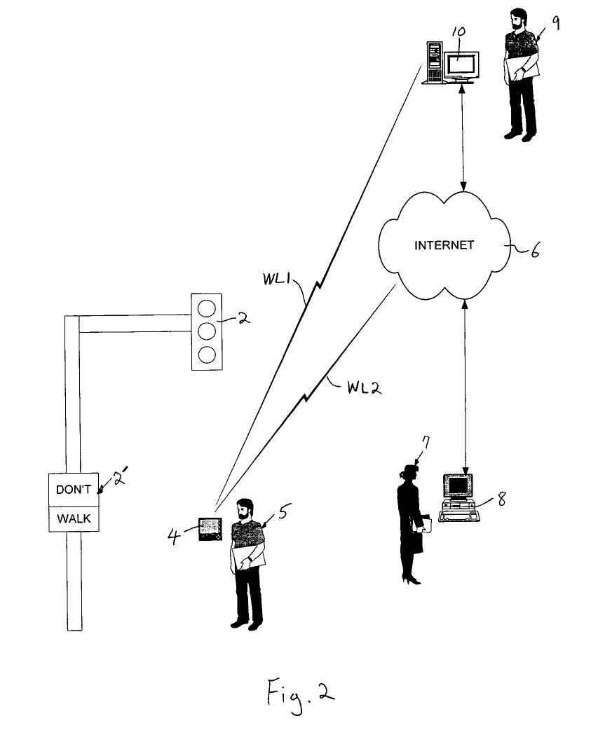

The schematic illustration of FIG. 2 shows a diagram exemplifying one use of TIMS 10 shown in FIG. 1 for effectively managing transportation infrastructure having a plurality of transportation devices. In this regard, a municipality or a city may have thousands of such transportation devices. As can be appreciated, the large number of transportation devices such as traffic signals, flashing signals, lane signals, pedestrian signals, street lamps, signage lamps, fiber optic signals, etc. in any given municipality or city, makes servicing and maintenance of these devices very difficult to effectively manage. For example, each intersection may have four or more of such transportation devices, and a municipality or city may have hundreds of intersections in their jurisdiction. In addition, these plurality of transportation devices may be of different types, each type of transportation device having different service requirements.

As shown in FIG. 2, technician 5 may be dispatched to service and/or maintain transportation devices 2 and 2′. As shown, the transportation device 2 is a traffic signal whereas the transportation device 2′ is a pedestrian signal. Of course, these are merely examples and the use of TIMS 10 as described below is equally applicable to any other types of transportation devices. During and/or after service of the transportation devices 2 and 2′, data associated with the service and/or maintenance of these transportation devices is recorded by the technician for entry into the database 14 of TIMS 10 shown in FIG. 1. Such data may include location of the transportation devices 2 and 2′ serviced, date and time of service, type of service performed, parts or components of the transportation devices 2 and 2′ replaced, etc. It should be understood that the term “service” and variations thereof are used in a broad sense herein below and refers to maintaining, repairing, upgrading, replacing, etc. of transportation devices.

Such data may be manually recorded on a work order form or the like which may have been used for dispatching the technician 5 to the location of the transportation devices 2 and 2′ for service and/or maintenance. Once the service and/or maintenance for the transportation devices 2 and 2′ have been completed, the recorded data may be entered into the database 14 of TIMS 10 in any appropriate manner. For example, the data may be manually entered into the database 14 of TIMS 10 by the technician 5 or a data entry personnel 9.

Of course, the data associated with the service of the transportation devices 2 and 2′ can be recorded and entered into the database 14 of TIMS 10 in any appropriate manner as well. For example, the data may be called in by the technician 5 to the data entry personnel 9 who may receive such data from numerous technicians in the field, and enter such data into the database 14 of TIMS 10.

FIG. 2 shows an optional implementation of recording and entry of data associated with the service and/or maintenance of the transportation devices 2 and 2′. In particular, such data is entered and stored by the technician 5 into a data acquisition unit 4 as shown which is adapted to interface with TIMS 10 to facilitate acquisition and uploading of data associated with the service and/or maintenance of the transportation devices 2 and 2′. The data acquisition unit 4 may be a personal computer, handheld computer, PDA, etc. which is portable to allow ease of use on site. In the illustrated example implementation of FIG. 2, the uploading of the data may be attained by establishing a wireless link WL1 using any appropriate wireless technologies such as radio signal based technologies.

The wireless link WL1 may alternatively be a local wireless link to allow uploading of data when the data acquisition unit 4 is in close proximity to TIMS 10. For example, the wireless link WL1 may be implemented using infrared or radio signal based technologies such as Bluetooth. Of course, any other appropriate communication link may be used by the data acquisition unit 4 to upload data associated with the service and/or maintenance of the transportation devices 2 and 2′. For example, a cable may be provided to allow interfacing and transferring of data from the data acquisition unit 4 to TIMS 10, such as through a serial or parallel data connection. Alternatively, the data acquisition unit may be provided with a removable memory device such as flash memory, memory stick, magnetic disk drives, CDRW, DVD-RW, or other appropriate solid state memory devices, to allow uploading of the data from the data acquisition unit 4 to TIMS 10.

As also shown in FIG. 2, the illustrated embodiment of TIMS 10 is connected to a distributed network such as the Internet 6. Such connection of TIMS 10 to the Internet 6 allows remote users such as administrator 7 of the municipality or the city to access data and information stored in TIMS 10. Such access may be established by the remote user 7 via a client device 8 that is also connected to the distributed network. The client device 8 may be any appropriate device for accessing data and information provided by TIMS 10 through the Internet 6. For example, the client device 8 may be a personal computer, handheld computer, PDA, etc. and may be provided with a display device, such as a monitor or LCD to display the retrieved and/or processed data from TIMS 10.

The connection of TIMS 10 to the Internet 6 as shown in FIG. 2 also allows the data acquisition unit 4, if provided, to upload data associated with the service of transportation devices 2 and 2′ remotely via the Internet 6 by a wireless link WL2. This can be readily attained using radio signal based technologies and services including wireless Internet access provided by telecommunications companies and the like. Of course, it should also be noted that whereas in the present implementation, distributed network is implemented as the Internet 6, it should also be noted that the distributed network may be a private, proprietary network in other implementations.

As previously noted, the administrator 7 may be an employee of the municipality or government agency that has the responsibility for maintaining the transportation infrastructure. Of course, whereas the illustration of FIG. 2 merely shows two transportation devices, it should be readily apparent that in a large urban city or municipality, thousands of such devices must be maintained and serviced which makes the task of managing the transportation infrastructure by the administrator 7 very difficult. This task is greatly facilitated by TIMS 10 in accordance with the present invention. In particular, various modules of TIMS 10 in accordance with the illustrated embodiment of the present invention greatly facilitates monitoring, tracking, scheduling, inventorying, and reporting on the service of transportation devices as described in further detail below.

Referring again to the embodiment of TIMS 10 as shown in FIG. 1, the monitoring module 20 facilitates monitoring of work order activity based on the status of the work order, and allows the details of the work orders to be viewed and/or printed. In particular, the monitoring module 20 extracts data stored in database 14 of TIMS 10 to provide status information of work orders by classifying the work orders as being “active” which indicates that the work order is in progress, “open” which indicates that the work order is incomplete, and “complete” which indicates that the work order has been completed. Various information regarding each of the work orders may also be provided by the monitoring module 20. For example, the following information regarding the work orders may be provided: the work order number; the data when the work order was generated; location identification number assigned by the municipality; street intersection name; and status of the work order which may be provided as a percentage of completion or as a textual message. The monitoring module 20 may also be adapted to provide a listing of work orders in review status during a “review period” in which, for example, work orders are subject to authorization from an administrator of the municipality or the like.

Referring again to FIG. 1, the work order module 30 of TIMS 10 is adapted to allow work orders to be viewed, searched, and for authorized users of TIMS 10, work orders to be created, modified, and/or canceled. In particular, the work order module 30 allows viewing of work orders that are categorized in any appropriate manner, for example, by party that generated the work order. In addition, the work order module 30 may be adapted to allow viewing of “awaiting work orders” which are in progress, but are awaiting further instructions for completion, are in parts related hold status, or are in need further work from a third party such as a utilities provider.

In addition, authorized users such as administrator 7 of the municipality or city can utilize the work order module 30 to create new work orders for servicing transportation devices. The work order module 30 also allows such authorized users to modify existing work orders. For example, a technician 5 may be dispatched to service the transportation device 2 which is malfunctioning by replacing the light bulbs used therein. However, it may later be found that the power management device of the transportation device 2 is the reason for the malfunction. Correspondingly, the work order that was issued for servicing the transportation device 2 may be modified to reflect the change in the required service. Moreover, the work order module 30 may also be used to cancel existing work orders if the work order is no longer required or was erroneously generated.

When TIMS 10 is connected to a distributed network such as the Internet 6 as shown in FIG. 2, the administrator 7 can create, modify, and/or cancel work orders via the work order module 30 of TIMS 10 to authorize and provide instructions for servicing transportation devices from a remote location. The work order module 30 may especially be advantageously used in applications of TIMS 10 when the work to be performed is contracted out to another party by the municipality since remote access and control of the work orders allows effective monitoring and tracking of service for transportation devices of a municipality or city.

The navigation module 40 functions to allow manipulation and searching of data stored in the database 14 that is associated with the plurality of transportation devices. In particular, the navigation module 40 may be used to retrieve work orders and information associated with specific type of service and/or maintenance. For example, work orders and associated stored data for group relampings, preventive maintenance, school flashers, and fiber optic signals may be retrieved from the database 14 of TIMS 10. In addition, information regarding field conditions associated with a particular transportation device or intersection, as well as trouble calls associate therewith may be accessed using the navigation module 40. Moreover, internal records of work orders being processed by the municipality or city may be accessed by the navigation module 40.

Preferably, the navigation module 40 allows the work orders to be searched based on numerous parameters such as the work order number, date, location, status, or other appropriate parameter. In this regard, the navigation module 40 is adapted to display the data log of the work orders based on the search parameters specified. This allows quick and easy retrieval of a work order and history associated with a particular transportation device for reviewing and/or printing.

The power outage module 50 informs the users of TIMS 10 of scheduled power outages which can impact servicing and maintenance of transportation devices. The power outage module 50 is preferably adapted to identify the time and duration of any power outages scheduled by the power company serving the municipality or city. In addition, the power outage module 50 also identifies the areas that will be affected by the power outage. Based on this information, service of the areas affected by the power outage may be appropriately scheduled. The power outage module 50 may also be interlinked with various other modules of TIMS 10, for example, the power outage module 50 may be interlinked to the work order module 30 to flag any work orders scheduled at that time to ensure that preventive maintenance or other service is not scheduled during this time since the proper operation of the transportation devices cannot be verified until power is restored.

An optional location identification module 55 may also be provided in TIMS 10 as shown in FIG. 1 which facilitates searching of transportation devices at specific intersections or locations, and viewing of detailed service history related thereto. The location identification module 55 may be used to search the database 14 of TIMS 10 based on an intersection identification number that is assigned by the municipality or city, or by the street names of the location or intersection. In addition, upon identifying the desired intersection, detailed data information regarding service history related thereto can be retrieved for review.

The administration module 60 of TIMS 10 shown in FIG. 1 allows authorized administrator 7 to access various database functions and features which are under the control of the municipality or city. In this regard, access to the administration module 60 may be restricted so as to prevent unauthorized use. For instance, the administration module 60 may be adapted to allow the administrator 7 of the municipality to create access for new end users, issue work orders, make changes or modifications to work orders, etc. Moreover, the administration module 60 of TIMS 10 may be adapted to allow performance of various administrative tasks that are associated with managing the transportation infrastructure. For example, the administration module 60 may be provided with features for accessing information regarding dispatchers, trouble calls, users accessing TIMS 10, etc.

As also shown in FIG. 1, TIMS 10 also includes a reporting module 70 that allows generation of various reports for viewing and/or printing data and information stored in the database 14. Reports may be generated by the reporting module 70 based on various different parameters. For example, the reporting module 70 may be used to generate a report showing recent activities and trouble calls as well as preventive maintenance for the different types of transportation devices. In addition, reports may be generated based on the status conditions of work orders and/or through a range of dates.

The reports may be generated and displayed by the reporting module 70 as a listing with related information associated with each work order, additional details of which can be further expanded and displayed by selecting a particular work order or intersection identification number on the report. For example, a daily activity menu item may be provided which displays repair and preventive maintenance work from the last shift cycle. Such information may also be displayed by selecting a date from a calendar or other search criterion. A repair screen may be displayed using a range of dates, and further customized by selecting the status of the work order or other parameters. In addition, the reporting module 70 may further be used to display selected information associated with preventive maintenance based on range of dates, and be further customized based on work order status, date range, categorization, and/or specific transportation device type, etc.

TIMS 10 as shown in the embodiment of FIG. 1 is also provided with an inventory module 80 that allows monitoring of ordered, stored, and installed materials and components for the transportation devices. In particular, the inventory module 80 may be adapted to provide details for the inventory of materials and components at a specific intersection location. Moreover, the inventory module 80 may further be adapted to display information such as when and where components were installed per work order number, date, or be cross referenced to other parameters. Furthermore, additional features may be provided by the inventory module 80 such as generation of materials quantity alerts that are sent to an appropriate administrator when quantities of a particular component or material needs to be replenished.

TIMS 10 as shown in the illustrated embodiment of FIG. 1 is also provided with an activity module 90 which allows monitoring of the various activities being undertaken by the work crews as well as other administrative functions associated with the management of the work crews. In particular, the activity module 90 may be adapted to allow entry of data associated with the transportation devices, as well as time and payroll data associated with a work crew member and/or a work order. Furthermore, the activity module 90 may further be adapted to list the members of various work crews as well as members of a work crew that is working on a particular shift. Moreover, additional information may be provided to facilitate managing of accounting and billing activities.

Referring again to FIG. 2, TIMS 10 in accordance with one embodiment of the present invention may connected to a distributed network such as the Internet 6. In this regard, TIMS 10 may be implemented as a website. This allows remote access by administrator 7 as well as technicians 5 that service and maintain the transportation devices such as the signal 2 and the pedestrian signal 2′ shown. In this regard, a SQL server may be used to implement TIMS 10 to allow retrieval of information stored in TIMS 10 in a rapid and efficient manner. An example website implementation of TIMS 10 and the various modules therein is described herein below. Of course, the implementation of TIMS 10 as described hereinbelow is merely one example, and TIMS 10 may be implemented in any appropriate manner in other embodiments of the present invention.

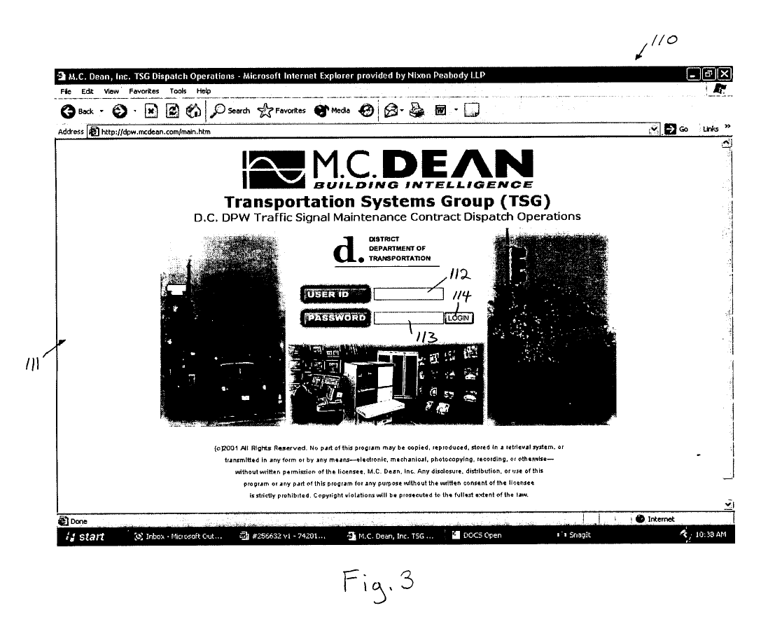

FIG. 3 shows one example implementation of a TIMS interface 110 in accordance with the present invention implemented as website http://dpw.mcdean.com. As evident from examination of FIG. 3, TIMS in accordance with one embodiment of the present invention has been accessed via the Internet using a browser program such as Microsoft Explorer®. Of course, other browser programs may be used such as Netscape Navigator®. It should be noted that the features of the browser program that is used to view and access TIMS which is implemented as a website is not part of the present invention, but is merely shown to more clearly illustrate access and use of a web implemented embodiment of the present invention.

Login screen 111 is shown in FIG. 3 in which a user must enter a user ID in the field 112 and a password in the field 113 to gain access to TIMS. In this regard, the TIMS interface 110 may be implemented with appropriate online security measures such as a firewall to ensure that only authorized personnel is given access to the data and information stored in TIMS. Of course in other embodiments, TIMS may be implemented so as to be publicly accessible without restrictions for merely viewing of information and data stored in TIMS.

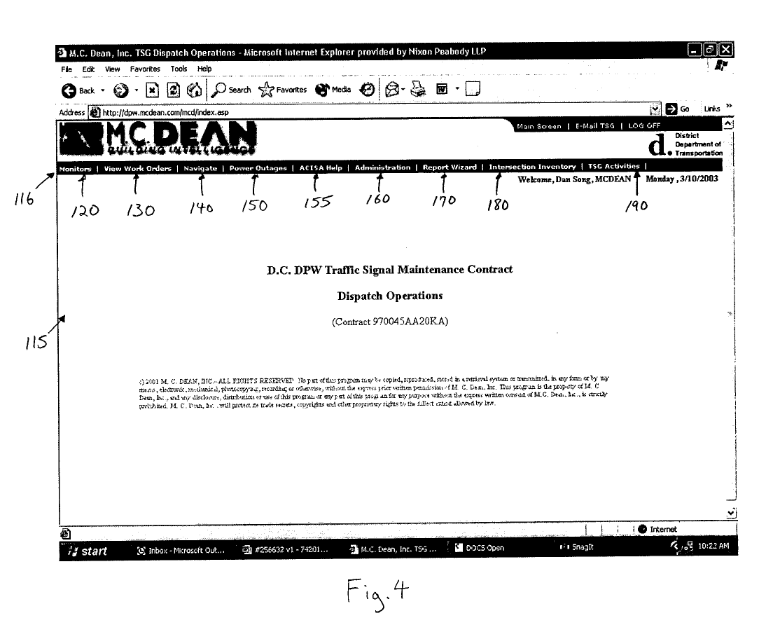

In the illustrated embodiment, after entry of the requested user ID and password in the login screen 111, the user clicks on the “LOGIN” button 114 to bring up main page 115 shown in FIG. 4. As shown, a toolbar 116 in the present embodiment is provided with dropdown menus or selections that correspond to the plurality of modules of TIMS 10 as discussed above relative to FIG. 1. The dropdown menus or selections allow the user of TIMS to access to the various functions and features provided by each of the modules through TIMS interface 110.

In particular, the toolbar 116 of the main page 115 of the illustrated embodiment is provided with the following dropdown menus: “Monitors” 120 which allow corresponding access to the monitoring module; “View Work Orders” 130 which provides access to the work order module; “Navigate” 140 which provides the user with access to the navigation module; “Power Outages” 150 which provides access to the power outage module; and “TSG Activities” 190 which provides the user with access to the function and features of the activities module, TSG referring to Transportation Services Group of M. C. Dean, Inc. In addition, the toolbar 116 of the main page 115 of the illustrated embodiment is provided with a plurality of selections such as: “ACISA Help” 155 which provides access to the location identification module, ACISA referring to Assigned Computer ID for Street Address described in further detail below; “Administration” 160 which provides access to functions and features of the administration module; “Report Wizard” 170 which provides access to the functions and features of the report module; and “Intersection Inventory” 180 which provides access to the functions and features of the inventory module.

It should be noted that in the various figures discussed in further detail below, same type of features, data and information such as the tool bar, scroll bar, work order numbers, and location ID numbers are indicated in these figures using the same numerals for clarity. It should also be noted that whereas in the illustrated implementation of TIMS as a website is provided with toolbar 116 having dropdown menus and selections corresponding to all of the modules of TIMS 10 of FIG. 1 discussed previously, other embodiments of the present invention need not be provided with all of these modules. In addition, whereas access to some modules are provided as dropdown menus while other modules are provided as mere selections in the toolbar 116, it should be understood that access to these modules may be implemented in any appropriate manner. Furthermore, access to modules implemented as selections may alternatively be implemented as dropdown menus and vise-versa. However, by providing the end user with access to the functions and features of each of the modules in the manner described in further detail below, the present invention provides an effective system for managing devices of a transportation infrastructure.

It should also be noted that whereas TIMS has been implemented with particular specificities, such details of the various modules and the web pages discussed hereinbelow are merely examples of how the present invention may be practiced, and should not be construed to limit the present invention. Moreover, whereas TIMS interface 110 discussed in further detail was implemented by M. C. Dean to manage the transportation infrastructure of the Commonwealth of Virginia and Washington, the District of Columbia, the present invention is also applicable to any municipality or city in facilitating management of the transportation infrastructures.

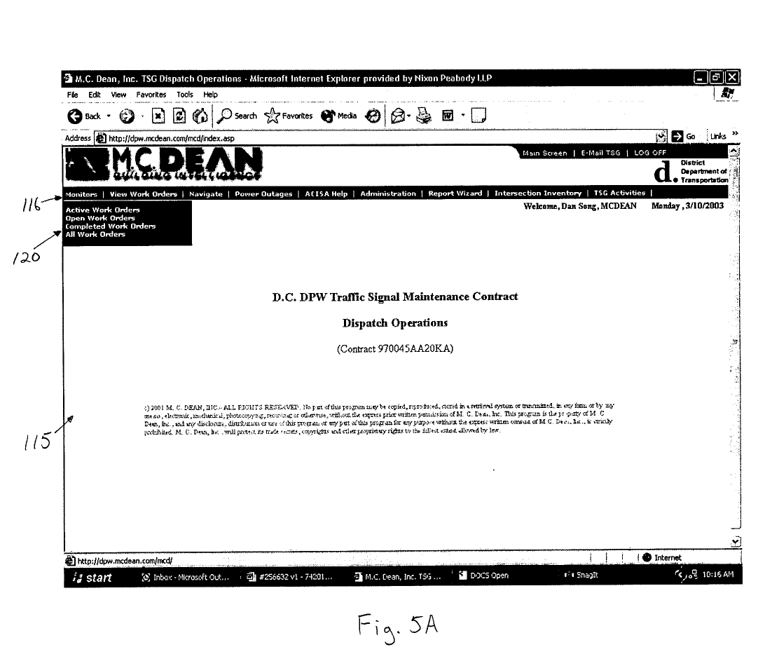

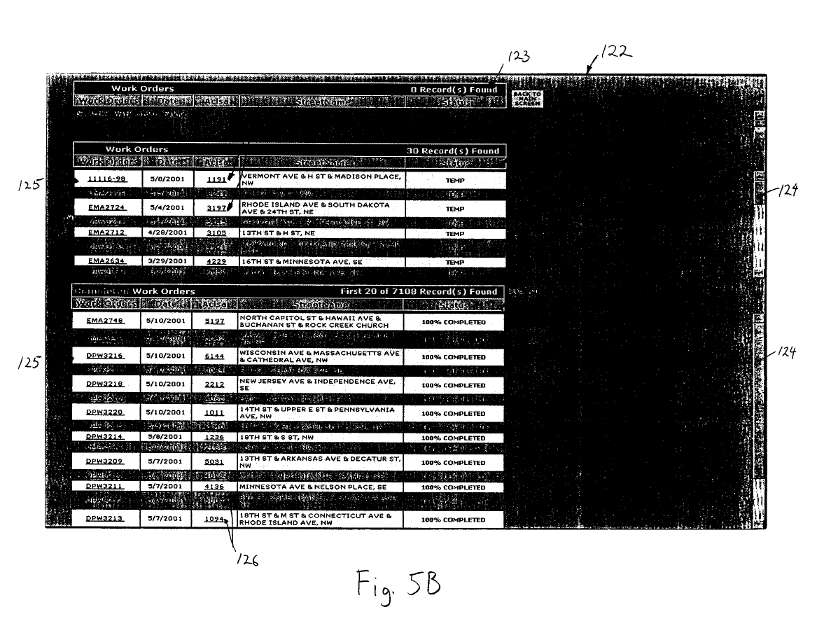

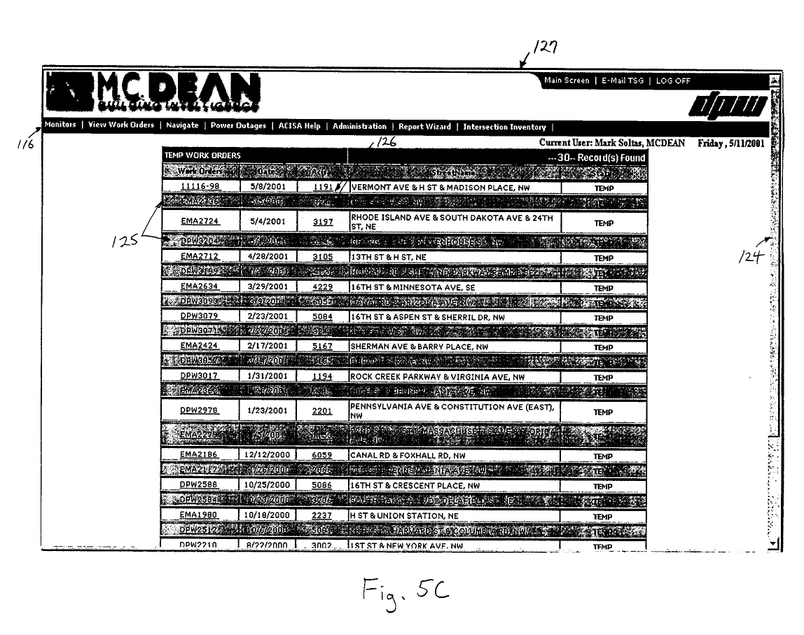

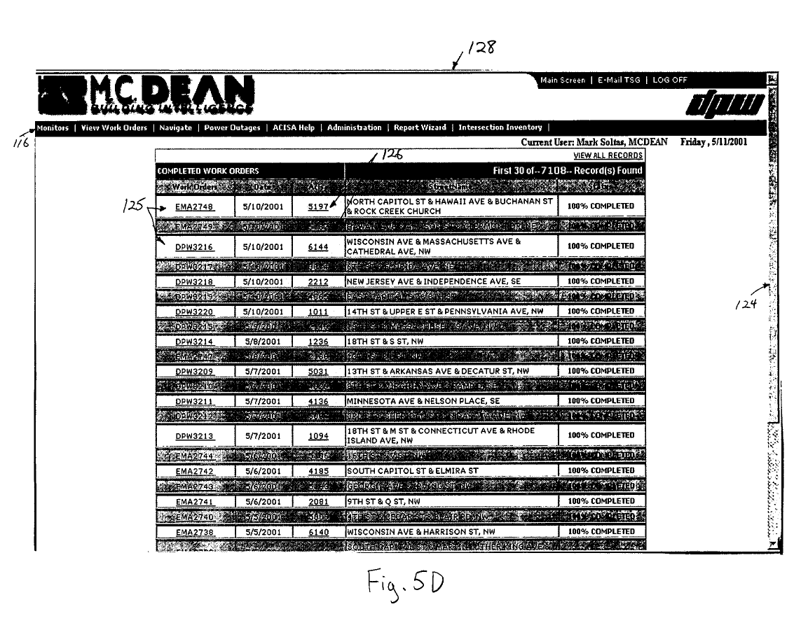

FIG. 5A shows an expanded view of the Monitors 120 dropdown menu that may be expanded by clicking on the text “Monitors”. Of course, in other embodiments, the text of the toolbar 116 that is associated with a particular dropdown menu may be implemented as trigger fields in which the dropdown menu is automatically generated and displayed by merely moving a cursor into the trigger fields. As shown in the illustrated implementation of the TIMS interface 110, the Monitors 120 dropdown menu is provided with various menu items which allow corresponding access to various functions and features of the monitoring module 20 of FIG. 1. In particular, the menu item “Active Work Orders” may be selected to display work orders that are presently active. Similarly, the “Open Work Orders” and “Completed Work Orders” menu items of the Monitors 120 dropdown menu allows corresponding display of open and completed work orders, respectively. Lastly, the menu item “All Work Orders” may be selected to view all types of work orders including active, open, and completed work orders.

In this regard, FIG. 5B shows an All Work Orders screen 122 that is displayed upon selection of the “All Work Orders” menu item in the Monitors 120 dropdown menu. As shown, active, open, and completed work orders are grouped together under separate headings 123. Furthermore, if there are more work orders than that can be displayed on the screen under the respective headings 123, corresponding scroll bars 124 are provided which may be used to scroll the displayed work orders to view the additional work orders under a particular heading 123. By providing different groupings on a single page and by providing corresponding scroll bars to allow viewing of all of the work orders, monitoring of the work orders for servicing transportation devices is greatly facilitated. In addition, each of the headings 123 are provided with various information associated with the work orders. In the illustrated embodiment of the All Work Orders screen 122, the work order numbers 125 are provided together with date of the work order, “ACISA” number 126 which is described in detail below, the street name, as well as the current status which may be textual and/or numeric information, for example, “50% Completed”. As previously noted, various figures discussed in further detail below same reference numerals are utilized for the tool bar, scroll bar, work order numbers, and location ID numbers for clarity.

In particular, further details of each of the work orders may be displayed by clicking on the desired work order number 125 in the All Work Orders screen 122. In this regard, each work order is preferably implemented as a link to the work order details. Moreover, information associated with the particular transportation device and/or intersection may be retrieved and displayed by selecting the desired ACISA number 126 which is also implemented as a link. ACISA stands for Assigned Computer ID for Street Address which is an identification system used by Washington, D.C. to categorize, and identifying intersections and locations so that service records can be associated with the transportation devices at that intersection or location. Of course, in other embodiments, identification numbers associated with intersections may be assigned in any appropriate manner by the municipality and/or city utilizing TIMS in accordance with the present invention. Upon selection of the desired ACISA number 126, i.e. the identification number for the intersection, information associated with the identified intersection may be displayed including past historical information and data associated with servicing of transportation devices at that intersection.

FIG. 5C shows an Open Work Orders screen 127 that is displayed upon selection of the “Open Work Orders” menu item in the Monitors 120 dropdown menu of FIG. 5A. As can be seen, the tool bar 116 is carried into the Open Work Orders screen 127 which allows rapid navigation for the user to access the functions and features of the other modules of TIMS. The Open Work Orders screen 127 displays all of the open work orders together with the work order number, the date and the intersection ID number, as well as the street name and the current status similar to FIG. 5B. Again, the work orders 125 as well as the identification numbers 126 are implemented as links to allow display of the particular details of the work orders and the intersections, respectively. In addition, scroll bar 124 is provided for viewing additional listings of open work orders.

Likewise, FIG. 5D shows Completed Work Orders screen 128 which may be displayed upon selection of the “Completed Work Orders” menu item in the Monitors 120 dropdown menu of FIG. 5A, the work order numbers 125 and the intersection identification numbers 126 being implemented as links to allow further display of detailed information. It should also be noted that although in the above implementations, work orders are sequenced in a reverse chronological order with the most recent work order being displayed at the top, the order may be altered in other embodiments of the present invention. Therefore, in the above described manner, the Monitors 120 dropdown menu provides access to the functions and features of the monitoring module 20 as described relative to FIG. 1.

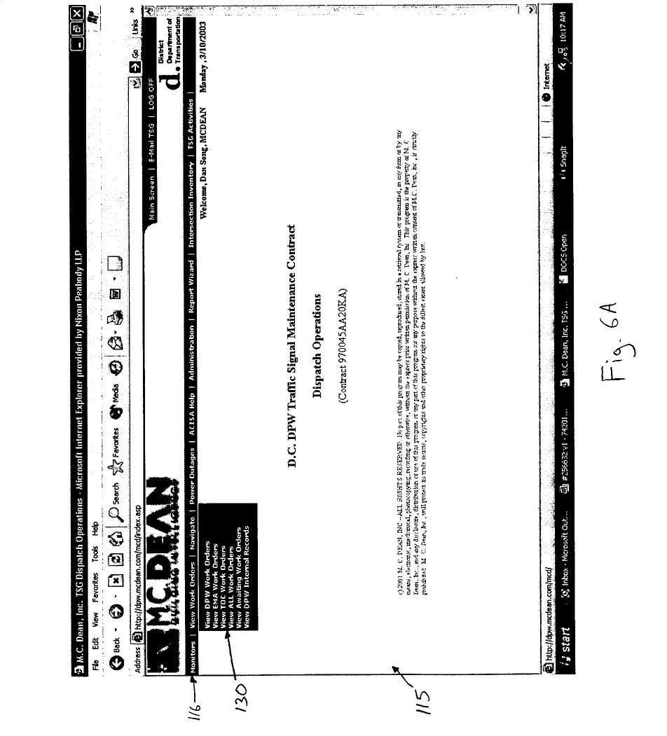

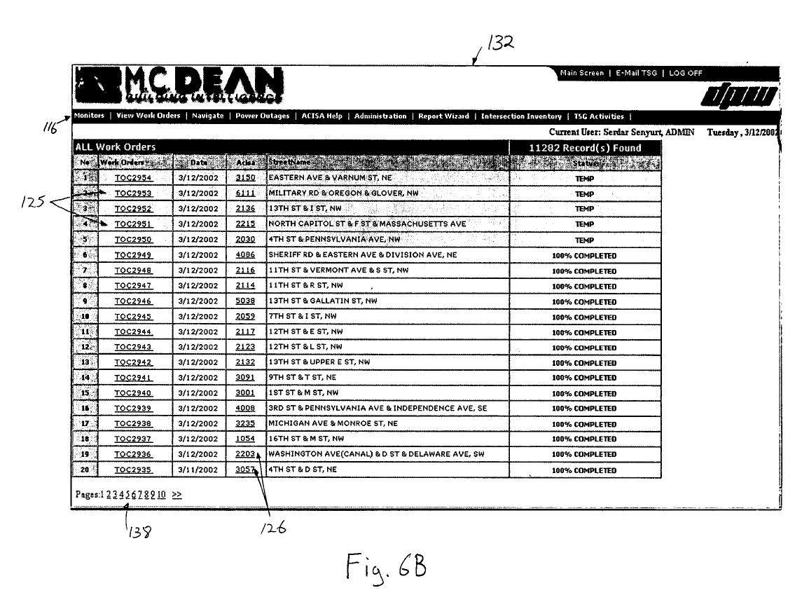

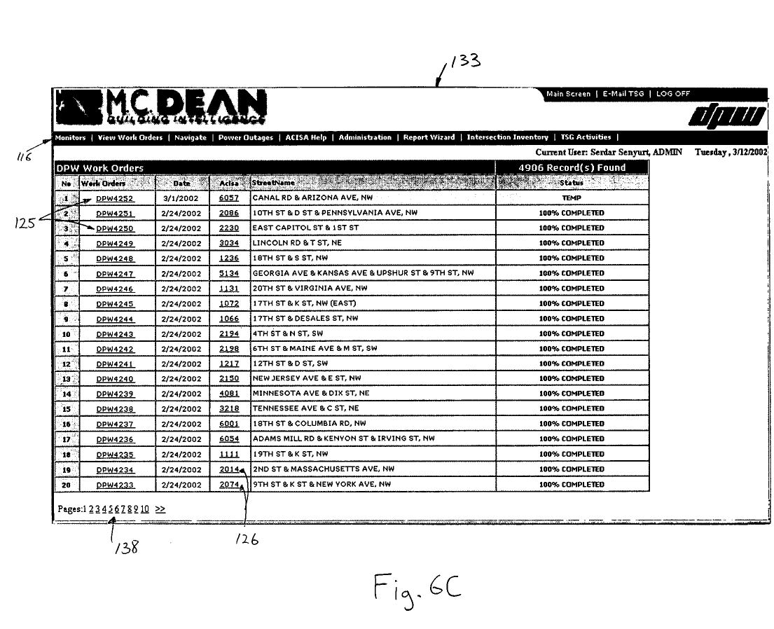

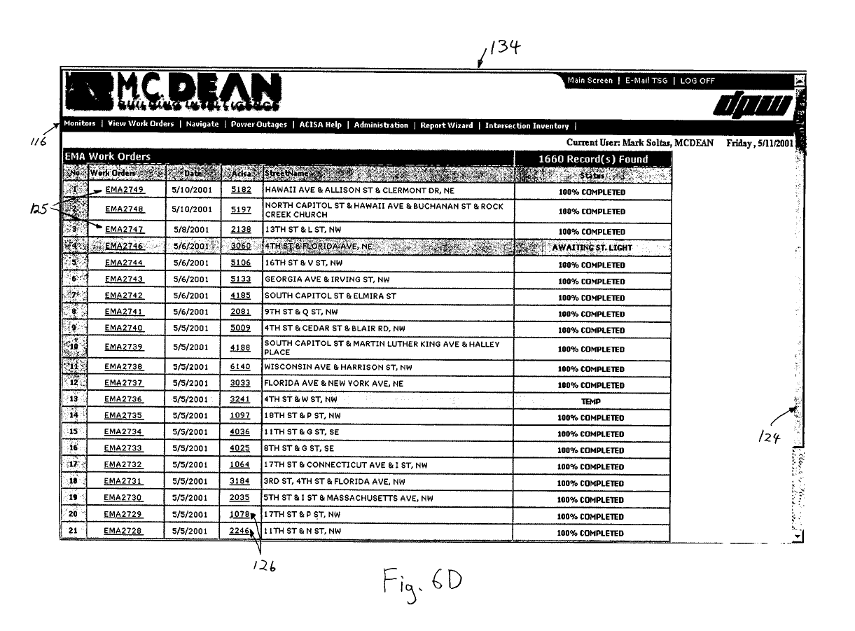

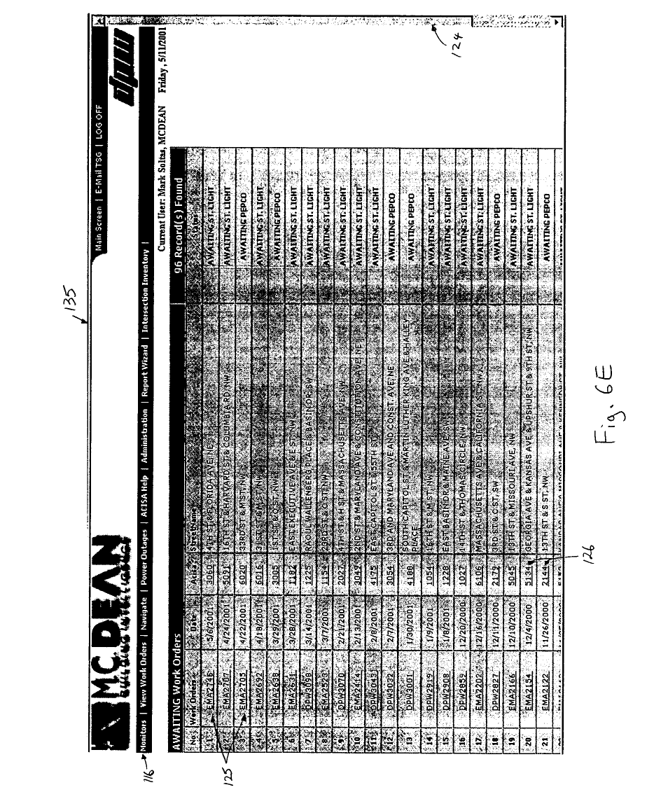

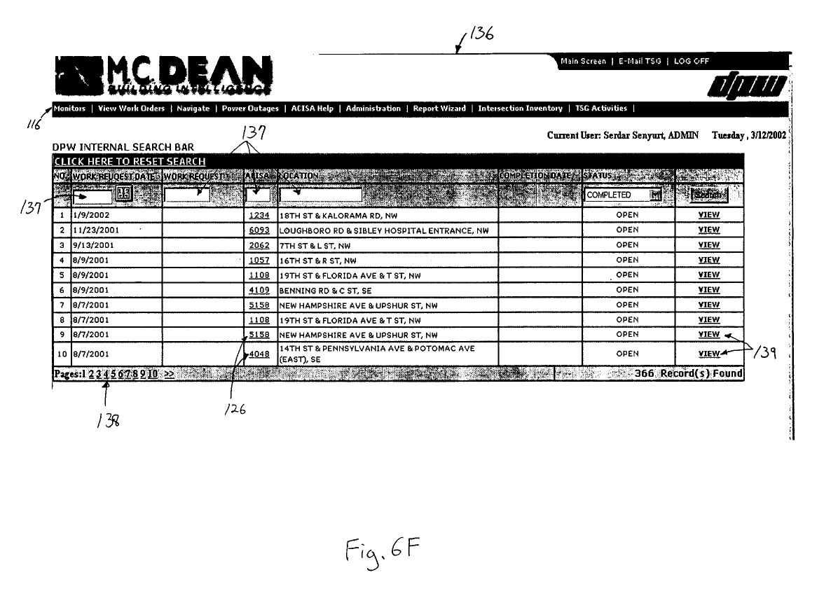

FIG. 6A shows main page 115 with “View Work Orders” 130 dropdown menu in its expanded form. As noted previously, the View Work Orders 130 dropdown menu provides access to the viewing functions and features of the work order module 30 described relative to FIG. 1. It should be noted that in the illustrated embodiment, only the viewing features of the work order module are allowed to be accessed by the View Work Orders 130 dropdown menu. However, in other embodiments, other functions and features of the work order module may be provided.

As shown in FIG. 6A, work orders which are generated by various parties can be displayed using the work orders module by selecting the desired menu item set forth in the View Work Orders 130 dropdown menu. In particular, in the illustrated example, work orders generated by the Department of Public Works (hereinafter “DPW”), Emergency Management Agency (hereinafter “EMA”), Traffic Operations Center (hereinafter “TOC”), or all of the work orders may be viewed by selecting the corresponding menu item in the View Work Order 130 dropdown menu. It should be noted that DPW generally manages the routine servicing of transportation devices whereas TOC manages requests for immediate service during normal business hours caused by malfunction or failure of the transportation devices and the like. EMA is a separate Washington, D.C. government agency apart from DPW which requests service of transportation devices after hours, weekends, and holidays when DPW and TOC is closed. Of course, these agencies are specific to Washington, D.C. only and other municipalities and cities may have a different operating structure for maintaining transportation devices. Correspondingly, the View Work Orders 130 dropdown menu may be implemented to correspond to the operating structure of the municipality or city to which the present invention is used.

In the above regard, it should be noted that in the illustrated implementation, the work orders are enumerated with prefixes which indicate the city or municipal agency that generated the work order. For example, referring to FIG. 5B, the prefixes “DPW” and “EMA” are inserted by TIMS into the work order numbers as shown to indicate that the Department of Public Works and Emergency Management Agency originated the corresponding work order. The use of such prefixes allows the viewer to immediately recognize the authoring agency of any work order and further allows categorization of work orders based on the originators which facilitates, for example, provision of View Work Orders 130 drop down menu as shown in FIG. 6A. Of course, it should be noted that this assignment of a prefix is only one exemplary method of distinguishing and classifying work orders and any appropriate method may be used.

Referring again to FIG. 6A, by selecting the “View All Work Orders” menu item of the View Work Order 130 dropdown menu, the All Work Orders screen 132 of FIG. 6B is displayed which lists all of the work orders 125 in the database of TIMS, and their respective status, regardless of who generated the work order. In the present implementation, the work orders 125 are listed in reverse chronological order and the work order numbers 125 are implemented as links which allow displaying of the full work order with the details and associated data. In addition, the intersection ID number 126 is also implemented as a link to allow access to historical data regarding service of transportation devices at that particular location.

FIG. 6C shows DPW Work Order screen 133 which is displayed upon selection of “View DPW Work Orders” menu item in the View Work Orders 130 dropdown menu shown in FIG. 6A. As shown, all of the work orders 125 displayed have been generated by DPW of the municipality and/or the city who are ultimately responsible for maintaining the transportation devices. The detailed information regarding each of the work orders 125 generated by DPW can be retrieved from the DPW Work Order screen 133 as well as information associated with the specific intersection or location. Additional work orders are displayable in the same format by selecting the pages link 138.

Of course, it can be readily appreciated that work orders generated by a different agency of the municipality and/or city may be selected and displayed separately. In this regard, FIG. 6D shows EMA Work Orders screen 134 that may be generated by selecting “View EMA Work Orders” menu item in the View Work Orders 130 dropdown menu. Work orders 125 and information associated therewith are displayed on the EMA Work Orders screen 134 in the same manner as discussed above relative to FIG. 6C. Moreover, additional work orders may be viewed by scrolling down the scroll bar 124.

Work orders that are awaiting further action by the municipality/city, or other third party, may be viewed by selecting “View Awaiting Work Orders” menu item of the View Work Orders 130 dropdown menu shown in FIG. 6A. FIG. 6C shows the corresponding Awaiting Work Order screen 135 which lists the work orders that are awaiting further action from the municipality or other third party. For example, the listed work orders may be awaiting repairs from the electric utility company or from a vendor of a component used in the transportation device. This information is preferably set forth in the “Status” column as shown.

Internal records of DPW may also be viewed by selecting “View DPW Internal Records” menu item of the View Work Orders 130 dropdown menu of FIG. 6A. FIG. 6F shows a DPW Internal Records screen 136 which allows viewing of records that are being developed or otherwise pending at the DPW thereby providing advanced notice of the upcoming work orders prior to official communication and issuance of work orders associated thereto. Moreover, the DPW Internal Record screen 136 further allows searching of the DPW records based on one or more parameters. In particular, parameters such as work request date, intersection ID number, location, etc. may be searched by entering the respective search parameters in search fields 137. In addition, further details of the DPW records may be viewed by clicking on link “VIEW” 139 that corresponds to the desired record.

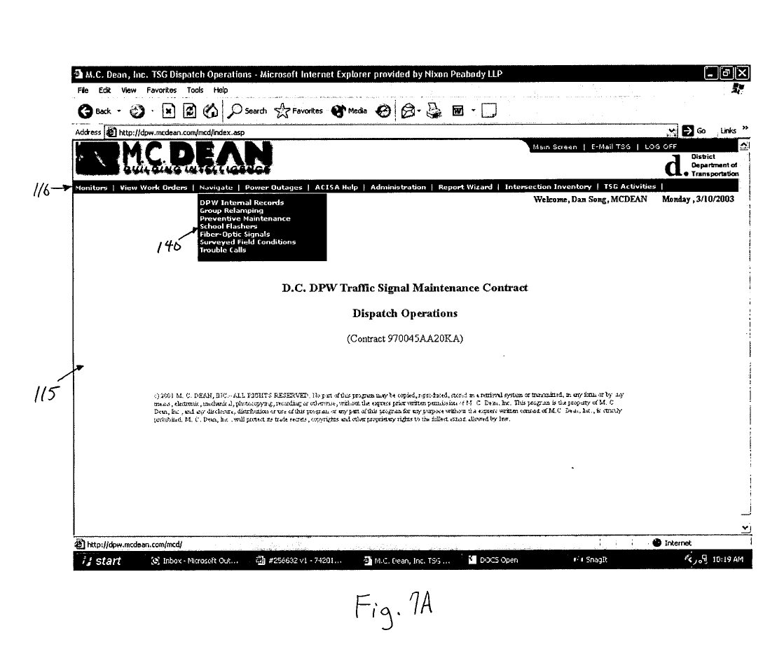

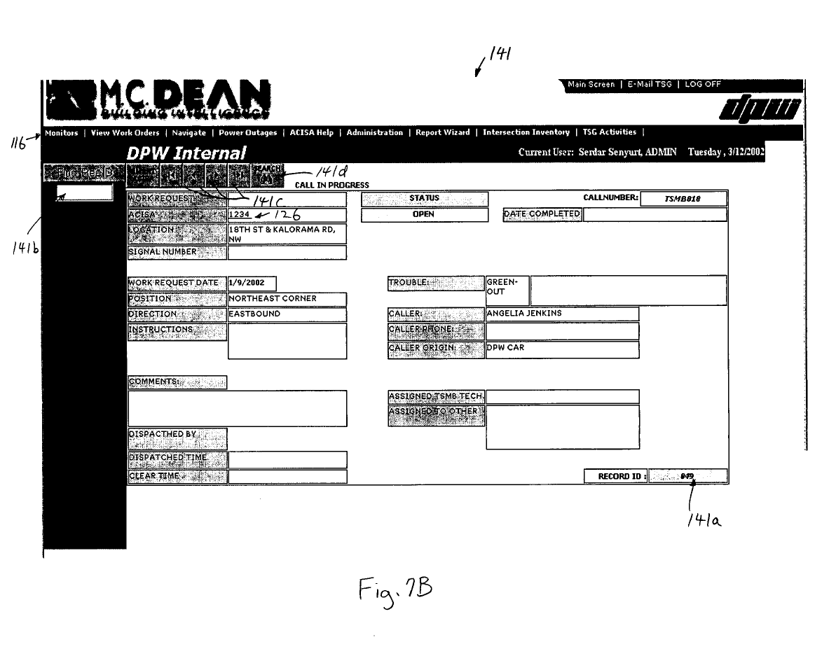

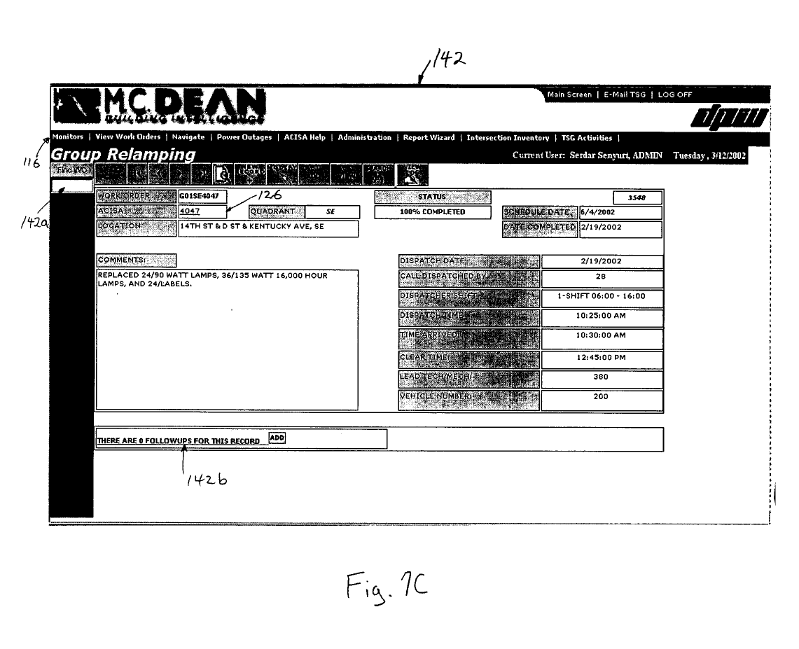

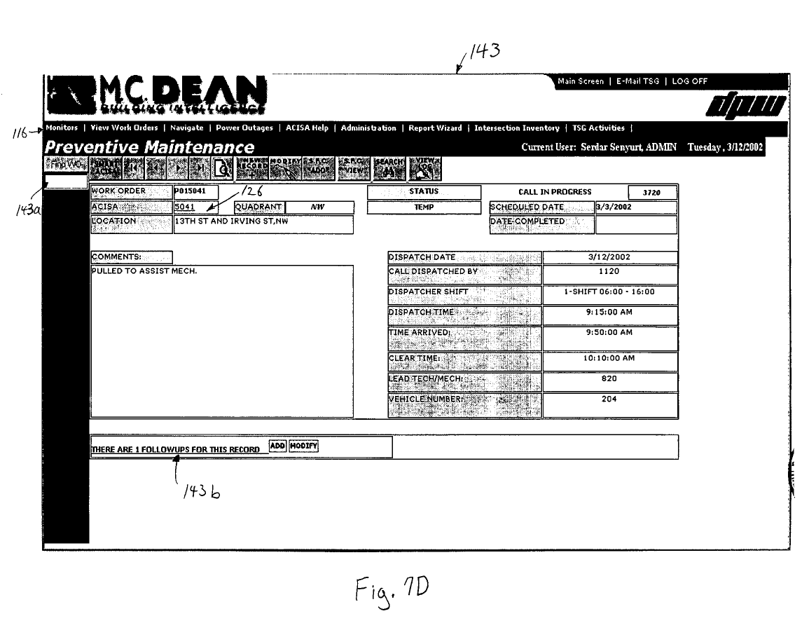

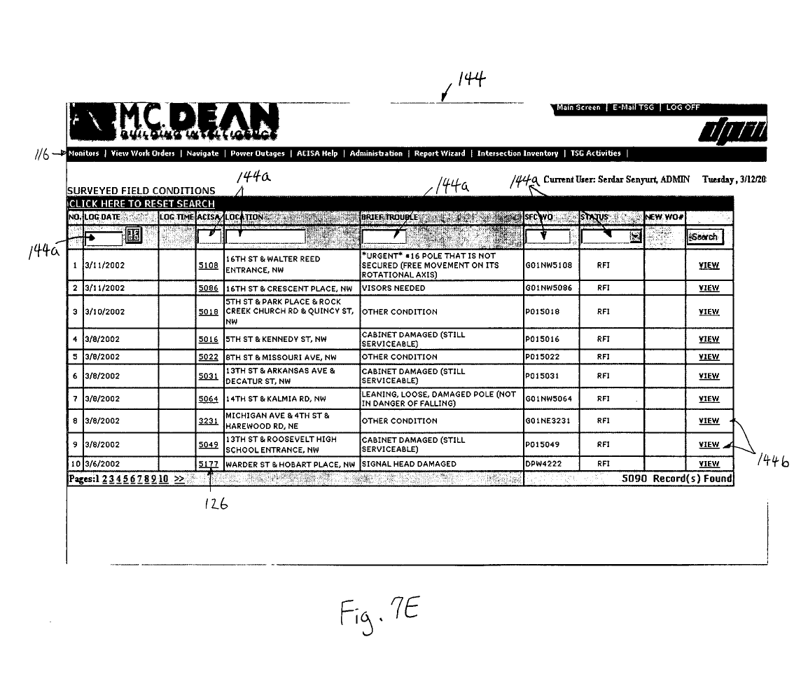

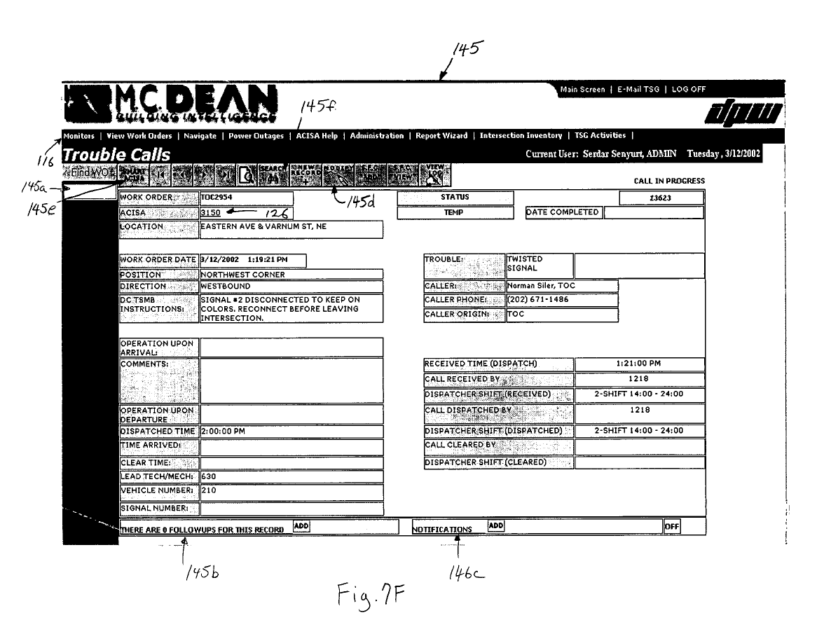

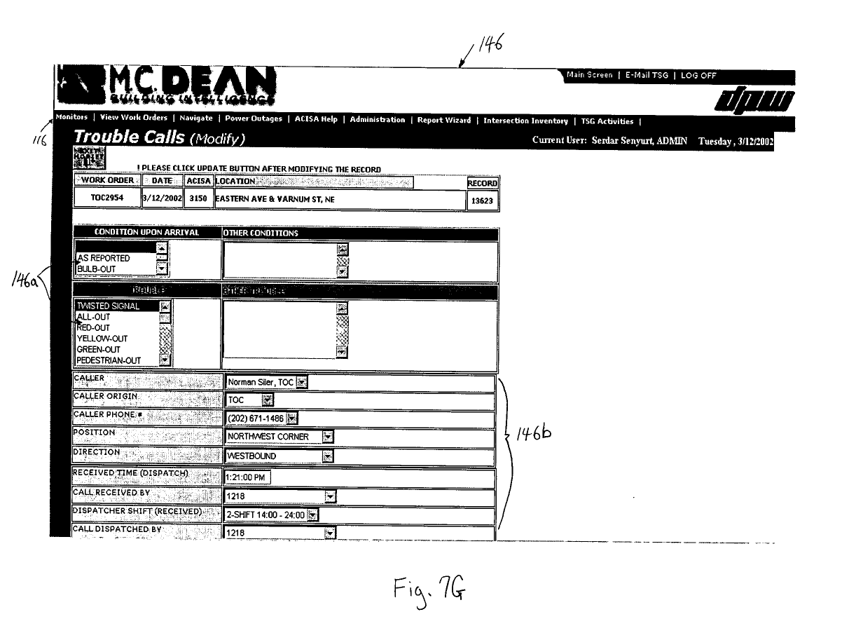

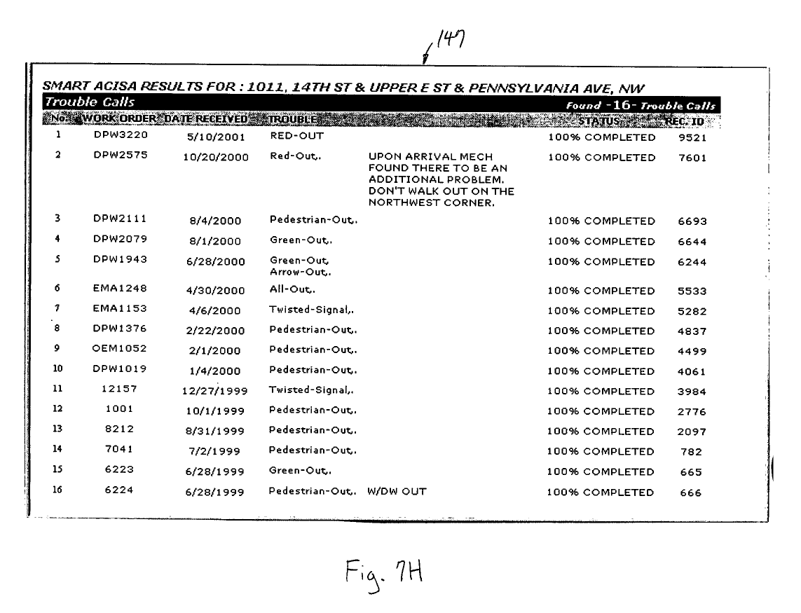

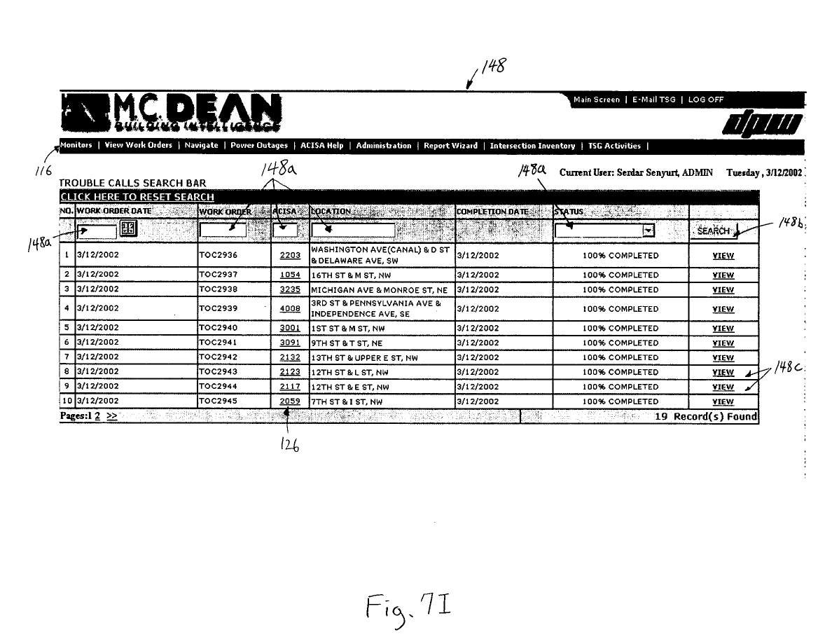

FIG. 7A shows the main page 115 of the web implemented embodiment of TIMS interface 110 shown in FIG. 3 in which the “Navigate” 140 dropdown menu is shown in its expanded form. The numerous menu items of the Navigate 140 dropdown menu provides access to the functions and features of the navigation module 40 described above relative to FIG. 1. In particular, complete access to the entire data log of service work orders may be accessed through the menu items provided in the Navigate 140 dropdown menu.

The selection of “DPW Internal Records” menu item in the Navigate 140 dropdown menu displays a DPW Internal screen 141 shown in FIG. 7B which shows a work order being generated or in process of being completed by the DPW. As shown, a record ID number 141a is assigned to each work order being generated and various information regarding the work order is shown by the DPW Internal screen 141. The intersection location is identified by the location ID number (i.e. ACISA number 126) and the work requested date as well as the type of trouble identified is set forth in the DPW Internal screen 141. The internal records of DPW may be searched by the record ID number 141a using the search field 141b since these records do not have a work order number. The internal records can also be navigated by selecting navigation buttons 141c and be searched using other parameters by selecting the search button 141d. Such access to DPW internal records facilitates preparation for required service of transportation devices in the municipality or city.

The selection of “Group Relamping” menu item in the Navigate 140 dropdown menu of toolbar 116 displays a Group Relamping screen 142 as shown in FIG. 7C. As shown in FIG. 7C, the Group Relamping screen 142 provides information and data associated with servicing of transportation devices at a particular location in which not all transportation devices need service. In particular, the Group Relamping screen 142 identifies the work order, location ID number, status, scheduled date, and completed date as well as dispatch information, etc. A search field 142a is provided for searching work order numbers and a link for follow ups 142b is also provided which allows the user to enter information or requests follow up records regarding a particular work order.

In transportation infrastructure management, it has become recognized that it is often desirable to change the lamps of all of the transportation devices at a particular intersection or location since the operational life of many of the lamps used in such transportation devices are substantially similar to one another. Therefore, to minimize multiple service trips to service each of the lamps in a relatively short span of time, all of the lamps may be replaced so that trouble free operation of the transportation devices can be ensured, at least until a predetermined duration of time based on the expected operational life of the replaced lamps.

The selection of the “Preventive Maintenance” menu item in the Navigate 140 dropdown menu of FIG. 7A displays the Preventive Maintenance screen 143 shown in FIG. 7D. The Preventive Maintenance screen 143 shows the status of a preventive maintenance work order at an intersection or location in the manner previously discussed relative to FIG. 7C. In addition, the status as well as the specific information associated with dispatching the technician to complete the preventive maintenance is provided in the Preventive Maintenance screen 143. Searching of work orders may be attained using the search field 143a and follow up information may be entered or viewed via the follow up link 143b.

In a similar manner to the above described group relamping and preventive maintenance, school flashers and fiber-optic signals may be maintained on an ongoing regular basis. Consequently, the Navigate 140 dropdown menu is further provided with “School Flashers” and “Fiber-optic Signals” menu items that display screens similar to those shown in FIG. 7C and FIG. 7D discussed above but with detailed information regarding work orders associated with maintenance of school flashers and fiber-optic signals, respectively. Hence, discussion of these display screens are omitted to avoid repetition. In this regard, the status and dispatch information as well as location information associated with service of school flashers and fiber-optic signals are also provided.

In addition, the selection of “Surveyed Field Conditions” menu item in the Navigate 140 dropdown menu of FIG. 7A generates the Surveyed Field Conditions screen 144 of FIG. 7E. As shown, the Surveyed Field Conditions screen 144 allows generation and maintenance of a log that identifies trouble items in need of service and/or maintenance at specific locations or intersections. For example, conditions that are observed during servicing of the transportation device can be inputted and displayed in the Surveyed Field Conditions screen 144 so that appropriate priority can be assigned for additional service in response thereto. In addition, the log entries may be searched by entering search parameters in any one of the search parameter fields 144a. Moreover, each log entry may be selected and viewed in further detail by clicking on the “View” link 144b.

The selection of “Trouble Calls” menu item in the Navigate 140 dropdown menu of FIG. 7A causes the display of Trouble Calls screen 145 as shown in FIG. 7F which provides detailed information regarding the location, identified trouble, and dispatch information. The Trouble Calls screen 145 may be used during course of daily operations to provide information about any trouble at an intersection or location. In addition, the Trouble Calls screen 145 may be used by an administrator or the like to notify contractors as to the nature of the trouble and its location. Moreover, such trouble calls may be effectively tracked and monitored using the Trouble Calls screen 145.

As can be seen, various detailed information including work order, location information such as the location ID number, instructions, nature of the trouble, and details of dispatch as well as the present status may be displayed in the Trouble Calls screen 145. In addition, a search field 145a is provided to allow searching of a work order associated with a particular trouble call. Furthermore, a follow up link 145b is provided to allow generation and viewing of follow up information associated with a trouble call. Moreover, a notifications link 145c is provided that allows the user to send notifications as to the disposition of the trouble calls when enabled.

In addition, the Trouble Calls screen 145 may further be provided with a modify button 145d which displays the Trouble Calls Modify screen 146 of FIG. 7G. The Trouble Calls Modify screen 146 may be used to modify all areas of a trouble call with updated information. In this regard, scroll menus 146a with standard language commonly associated with a trouble call may be provided for facilitating input of condition of the transportation device. Moreover, various dispatching information may be provided as well, dropdown menus 146b being provided to facilitate input of such information.

Referring again to FIG. 7F, the Trouble Calls screen 145 is also provided with smart ACISA button 145e which generates a history log of services performed on the transportation devices at the specific intersection or location identified by the location ID number (ACISA). An example Smart ACISA Result screen 147 is shown in FIG. 7H. As shown, the entire trouble history associated with an intersection or location, in this case, ACISA number 1011, is displayed. The information provided in such a manner may be readily used to determine the time intervals for preventive maintenance and/or relamping. In addition, the information provided by the Smart ACISA Result screen 147 may be used to further diagnose potential problems with the transportation device. For example, a continually reoccurring problem may merely be a symptom of another underlying problem which if unaddressed, will cause the transportation device to have continued symptomatic problems.

Furthermore, referring again to FIG. 7F, the Trouble Calls screen 145 may further be provided with a search button 145f that allows display of Trouble Calls Search screen 148 as shown in FIG. 7I. The Trouble Calls Search screen 148 may be used to search for any intersection using any one or more of various search parameters including location, ACISA number, work order number, date, and/or status by entering the search parameters in the appropriate search fields 148a. Then, the user clicks on search button 148b to display the results of the search. Moreover, full records of the work order may be viewed by selection of “VIEW” link 148c which displays the trouble calls screen 145 of the selected work order.

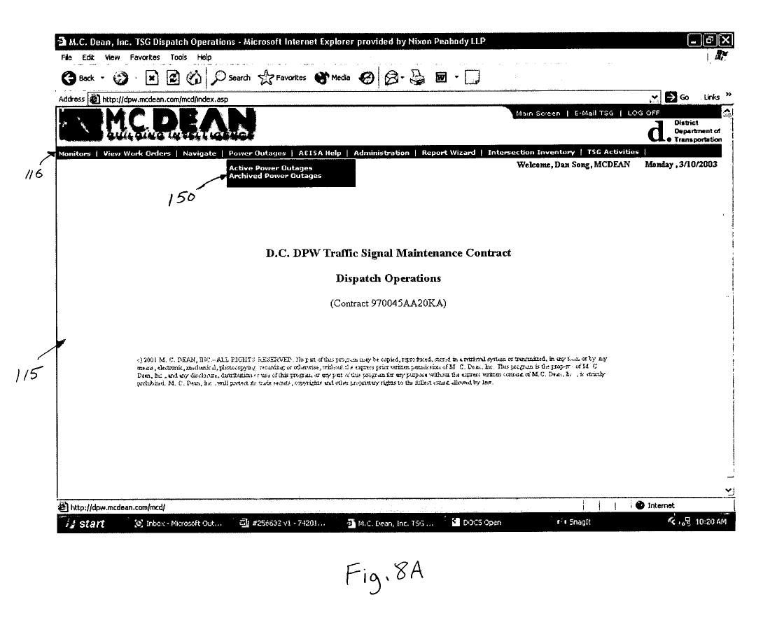

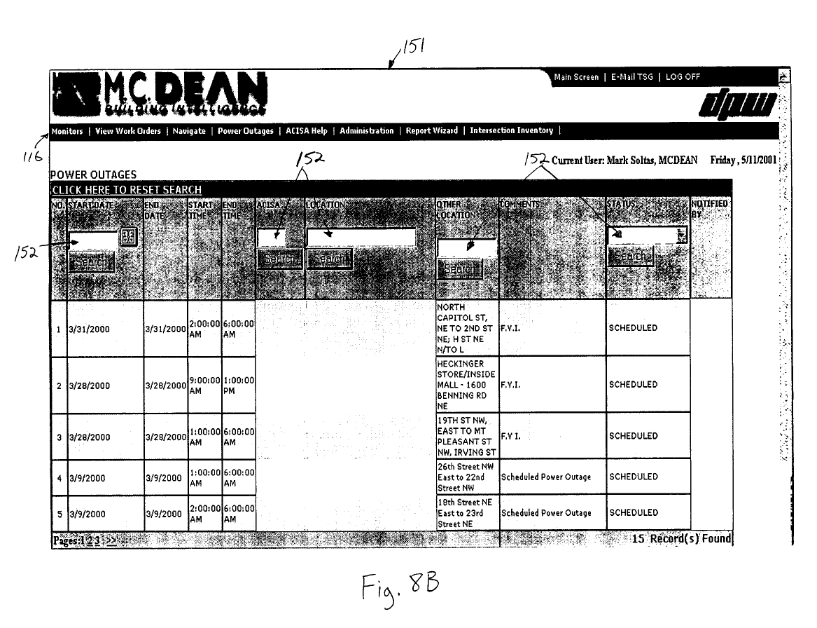

FIG. 8A shows main page 115 in which the Power Outages 150 dropdown menu of toolbar 116 is shown in the expanded form which allows access to the functions and features of the Power Outages module 50 discussed above relative to FIG. 1. In particular, the selection of “Active Power Outages” menu item of Power Outages 150 dropdown menu generates Power Outages screen 151 shown in FIG. 8B which chronologically lists the scheduled power outages as well as the duration and location of the power outages. Moreover, as also shown in FIG. 8B, power outages may be searched based on date, location ID number, location, etc. by entering the desired search parameter in the search fields 152. As can be appreciated, the information presented on the Power Outages screen 151 is preferably provided by the power utility company.

As previously discussed, power outages can impact servicing and maintenance of transportation devices. Thus, by providing such information on the Power Outages screen 151, scheduling servicing of transportation devices can be made appropriately. Referring again to FIG. 8A, past power outages can be viewed by selecting “Archive Power Outages” menu item from the Power Outages 150 dropdown menu. Such a selection will provide a searchable listing of past power outages that were scheduled. In this regard, the information of the archives may be displayed in a similar manner of that as shown in the Power Outages screen 151 of FIG. 8B.

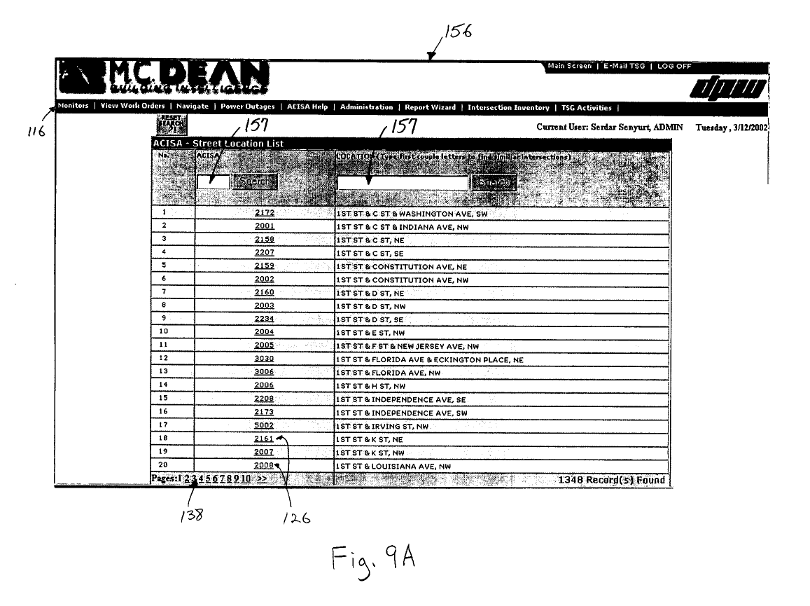

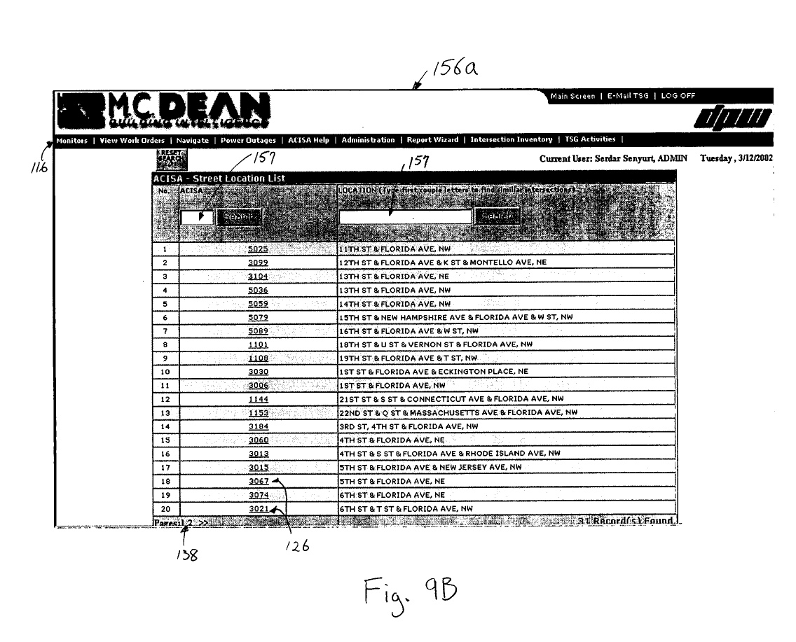

Referring again to FIG. 4, the selection “ACISA Help” 155 in toolbar 116 of the main page 115 displays the help screen 156 shown in FIG. 9A. As previously noted, ACISA refers to Assigned Computer ID for Street Address which is a system used by Washington D.C. for categorizing, and identifying intersections. Of course, in other embodiments, any appropriate location ID number may be assigned and used. The selection ACISA Help 155 provides access to the features and functions of the location identification module 55 discussed above relative to TIMS 10 of FIG. 1.

In particular, as shown, the help screen 156 provides the user of TIMS another way of searching for service information associated with a particular intersection or location. In this regard, the location ID may be searched for directly, or the location itself may be searched by entering the appropriate data into the search fields 157. As also shown, the ACISA numbers are implemented as links which if clicked upon by the user, generates the full record of services performed on the transportation devices at the intersection or location to which the selected ACISA number is assigned.

In addition, in the preferred embodiment of the present invention, the street location may be searched by entering few letters of a street name. For example, FIG. 9B shows the results of a search conducted by typing in the letters “flo” into the search field for location. As can be seen by the generated list, the location identification module identifies every intersection with the letters “flo” in it, whether it is at the beginning, middle, or at an end of an intersection. Additional search results may be viewed by clicking on the desired page link 138. Thus, it should be evident how the help screen 156 may be advantageously used to identify intersections where cross streets are a factor in searching.

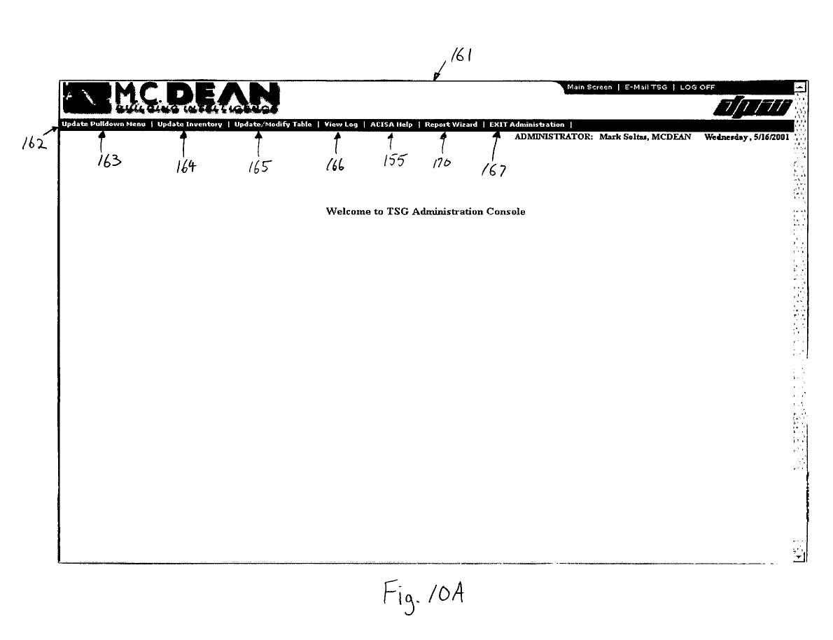

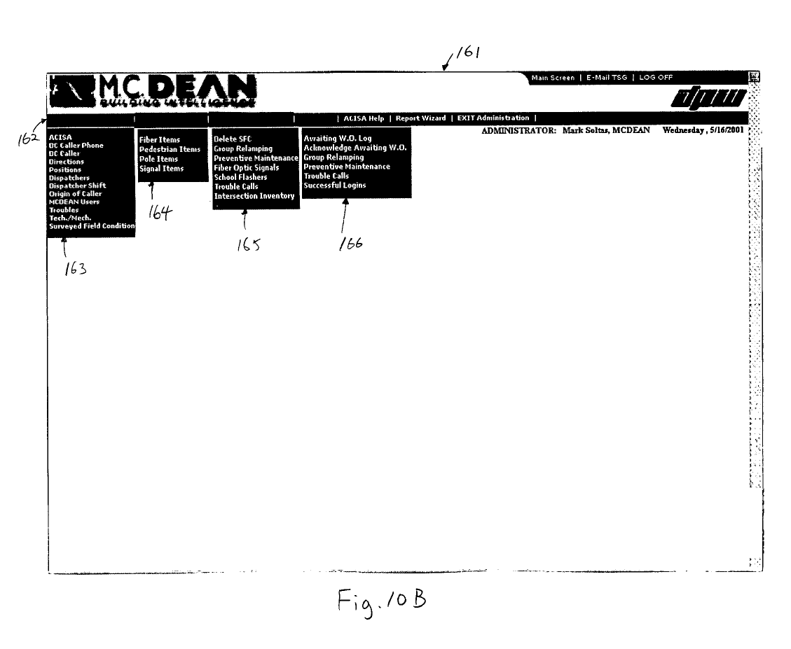

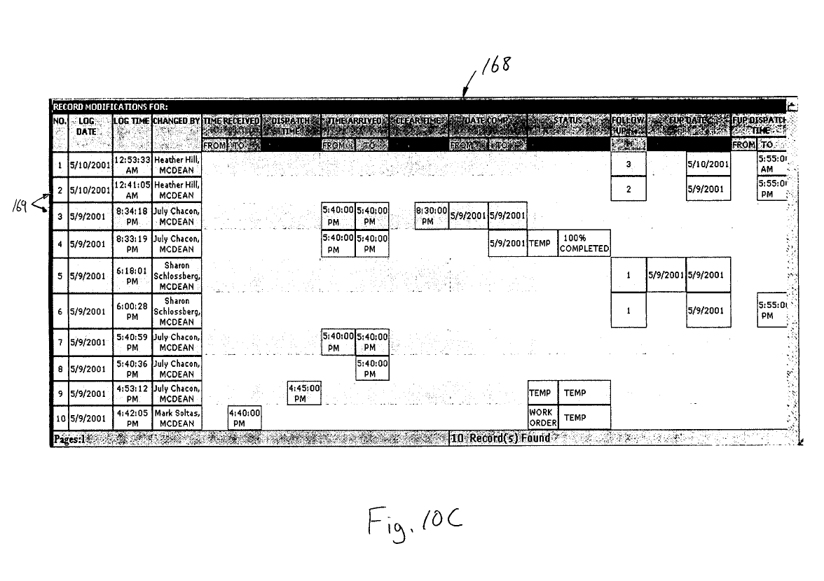

FIG. 10A shows an administration main screen 161 that is displayed upon selection of “Administration” 160 menu item in the toolbar 116 of the main page 115 shown in FIG. 4. As briefly described in further detail below, the administration screen 161 allows access to various database components and features which are under the control of the municipality or city. In this regard, access to the administration main screen 161 as shown in FIG. 10A may be severely restricted and may be based on the particular user ID and password entered in the login screen 111 shown in FIG. 3.

As also shown in FIG. 10A, the administration main screen 161 is provided with its own toolbar 162 that provide access to functions and features of the administration module 60 of TIMS discussed above relative to FIG. 1 as well as other modules that are accessible to the general user. As can be appreciated from the discussion herein below, the selections of the toolbar 162 of the administration main screen 161 as shown in FIG. 10A is tailored for administrators that manage the transportation infrastructure utilizing the TIMS interface 110 in accordance with the present invention. Thus, whereas many of the features and functions described with respect to the administrative module does not directly relate to the management of the transportation devices, the administration module facilitates management of the transportation infrastructure generally.

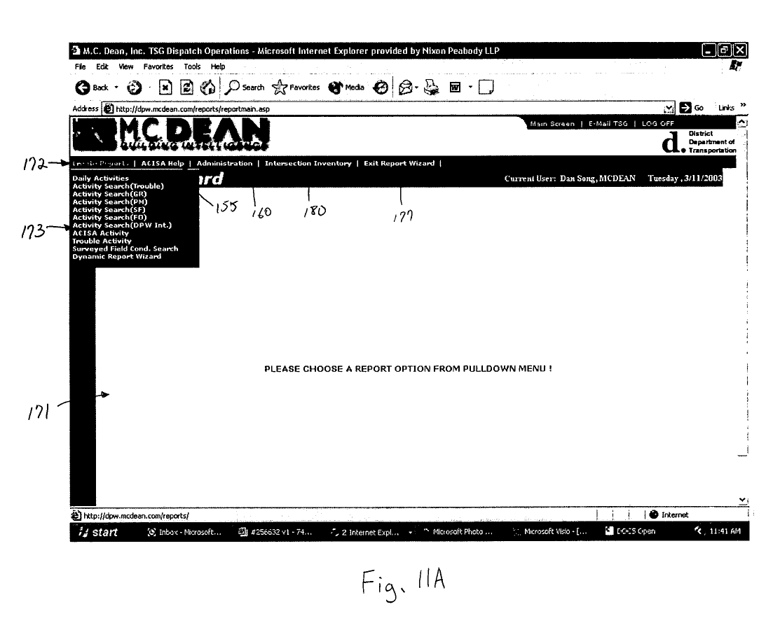

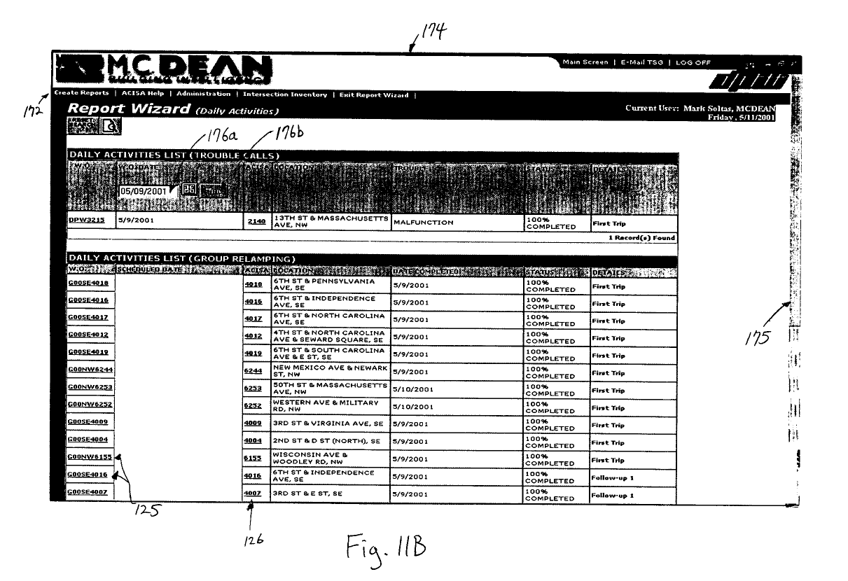

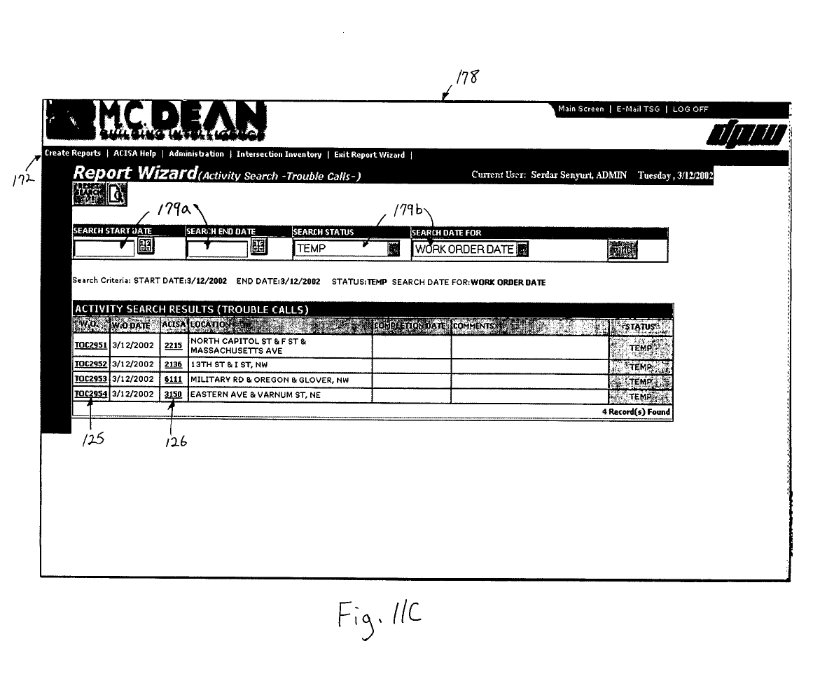

As shown, the toolbar 162 is provided with various dropdown menus including “Update Pulldown Menu” 163, “Update Inventory” 164, “Update/Modify Table” 165 and “View Log” 166. The toolbar 162 is also provided with selections including ACISA Help 155 selection. The ACISA Help 155 selection is a link to the location identification module previously described above relative to FIGS. 9A and 9B and thus, the functions and features are omitted herein to avoid repetition. In addition, the selection “Report Wizard” 170 of the toolbar 162 is a link to the reporting wizard that is discussed in further detail below relative to FIGS. 11A to 11C, and thus, is also omitted herein to avoid repetition. Lastly, the toolbar 162 is further provided with “Exit Administration” 167 selection that allows the user to return to the main page 115 as shown in FIG. 4.

FIG. 10B shows the administration main screen 161 but with the various dropdown menus in their expanded form. As shown in FIG. 10B, the “Update Pulldown Menu” 163 is provided with plurality of menu items for facilitating management of the transportation infrastructure. In this regard, these menu items allows administrators to change any field information within the database of TIMS. For example, ACISA numbers may be altered, caller information may be changed, directions for servicing a particular transportation device at a given intersection or location may be changed, dispatching information may be changed, caller information may also be changed. Moreover, personnel lists for contractors may be viewed and/or modified as well information regarding field conditions by selecting the appropriate menu item of the Update Pulldown Menu 163.

The “Update Inventory” 164 dropdown menu allows administrators to modify inventory fields by adding and/or deleting inventory item associated with each intersection or location. The inventory information may be delineated in the Update Inventory 164 dropdown menu for fiber-optics, pedestrian, pull, and/or signal transportation devices. Moreover, pictures may be added and/or deleted from TIMS to facilitate identification of transportation devices at a particular intersection or location. The “Update/Modify Table” 165 dropdown menu provides plurality of menu items for allowing administrators to modify records in the database of TIMS, including deleting and/or modification of information that normal TIMS users cannot modify. In particular, information associated with group relamping, preventive maintenance, fiber-optic signals, school flashers, trouble calls, and intersection inventory may be deleted and/or otherwise modified by selecting the appropriate menu item from the Update/Modify Table 165 dropdown menu in the administration main screen 161.

The “View Log” 166 dropdown menu in its expanded form is also shown in the administration main screen 161 of FIG, 10B that allows administrators to view screens showing awaiting work orders, group relampings, preventive maintenance, and trouble calls, all of which have been previously described. In addition, the administrator can also acknowledge awaiting work orders by selecting the “Acknowledge Awaiting WO” menu item of the View Log 166 dropdown menu. In addition, the administrator may further view listing of logins to TIMS by selecting “Successful Logins” menu item of the View Log 166 dropdown menu. Thus, this feature allows the administrator to monitor individuals that have been accessing TIMS. In addition, the information that is viewed via the View Log 166 dropdown menu may also be edited and modified in any appropriate manner by the administrator.

By selecting “Trouble Calls” menu item of the View Log 166 dropdown menu, the administrator can view what changes have been made to the records associated with the trouble calls. In this regard, FIG. 10C shows a Record Modification screen 168 which identifies a plurality of trouble call records 168a. Each record indicates what dispatcher worked on the record as well as date, time, and any status changes associated with a trouble call. In addition, any follow up information is also provided on the Record Modification screen 168. The information as provided in the Records Modification screen 168 as shown in FIG. 10C allows administrators to monitor the records quickly for quality control purposes to ensure that necessary servicing of transportation devices is provided in a timely manner. Moreover, the information provided by the Records Modification screen 168 can be used to question any dispatchers about information in various trouble calls as needed. Referring again to FIG. 10A, the administrator can exit the administration main screen 161 by selecting the “Exit Administration” 167 menu item which returns the administrator back to the main page 115 of TIMS as shown in FIG. 4.

FIG. 11A shows a reports wizard main screen 171 which is displayed by TIMS upon selection of the “Report Wizard” 170 menu item in the toolbar 116 of the main page 115 as shown in FIG. 4. The reports wizard main screen 171 is provided with a reports toolbar 172 that allows the user of TIMS to access the functions and features of the reporting module 70 discussed above relative to FIG. 1. In addition, in the illustrated example, links or dropdown menus to access other modules of TIMS is provided on the reports toolbar 172. For example, links or dropdown menus ACISA Help 155, and Administration 160 discussed previously, and Intersection Inventory 180 discussed below, is provided on the reports toolbar 172, the details of these links or dropdown menus being omitted herein to avoid repetition. In addition, “Exit Report Wizard” 177 link is provided to return the user to the main page 115 shown in FIG. 4.

The “Create Reports” 173 drop down menu is shown in its expanded form and may be used to generate various types of reports. For example, FIG. 11B shows report wizard screen 174 that is generated by the selection of “Daily Activities” menu item in the Create Reports 173 dropdown menu. The generated report of FIG. 11B shows daily activities, all group relamps, preventive maintenances and trouble calls, additional activities being accessible by scrolling scroll bar 175. The date parameter for the report may be changed by entering the desired date in the date search field 176a and clicking on the “Find” button 176b. As shown, the report shows the work order number 125, the schedule date, the ACISA number 126 (i.e. location ID number), location, date completed, status, and details. As can be appreciated, the work order numbers 125 and the ACISA numbers 126 are implemented as links to provide access to additional detailed information regarding the work orders and the intersection/location, respectively. Of course, FIG. 11B shows merely one example report and other types of reports may be generated using the reporting module of TIMS.

A report wizard trouble calls screen 178 is shown in FIG. 11C which is displayed upon selection of “Trouble Activity” menu item in the “Create Reports” 173 dropdown menu. In the generated report of FIG. 11C, the results of the search is displayed as a table which identifies the work order number 125, work order date, the ACISA number 126, the location, the completion date, any comments, as well as the status of the trouble calls. As can also be seen, the work order number 125 and the ACISA number 126 are provided as links so that the full record associated thereto can be displayed and viewed.

In addition, reports may be generated by searching the records of TIMS based on specific parameters such as the search start date and end date, as well as the status and the type of date being provided (for example, work order date versus completion date). In this regard, the report parameters may be entered in fields 179a and selected from dropdown menus 179b to allow generation of a customized report. Similar types of reports may be generated corresponding to preventive maintenance, group relamps, school flashers and fiber-optics by selecting the appropriate menu items of the Create Reports dropdown menu 173. Each of such reports would include similar searching parameters to allow viewing of records for daily, weekly, monthly or even yearly groups.

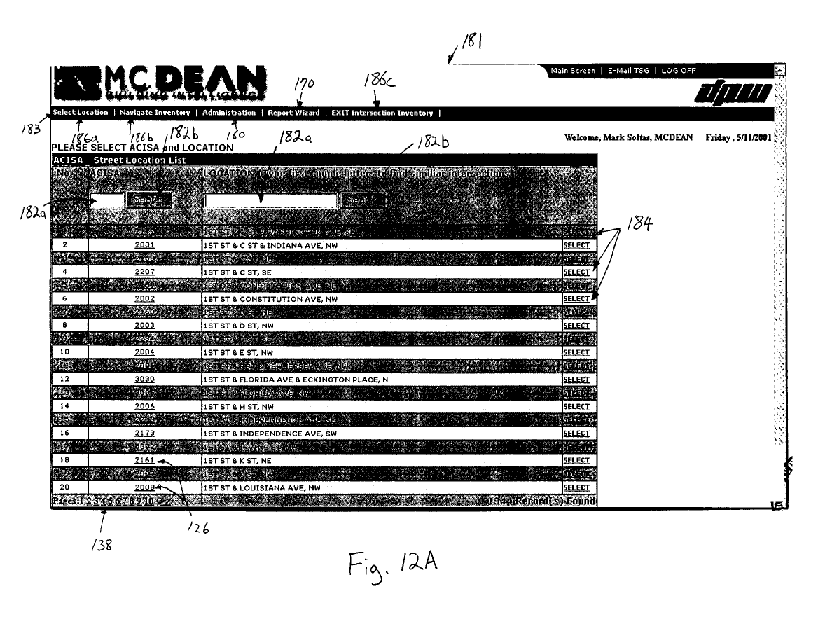

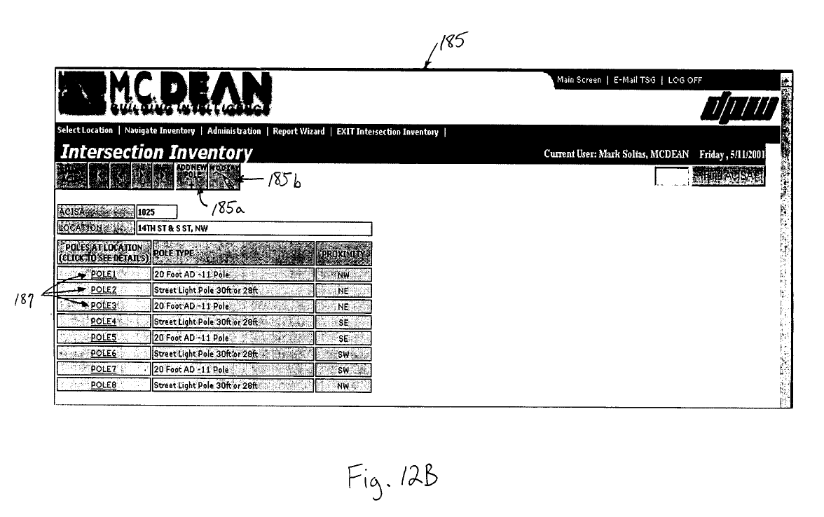

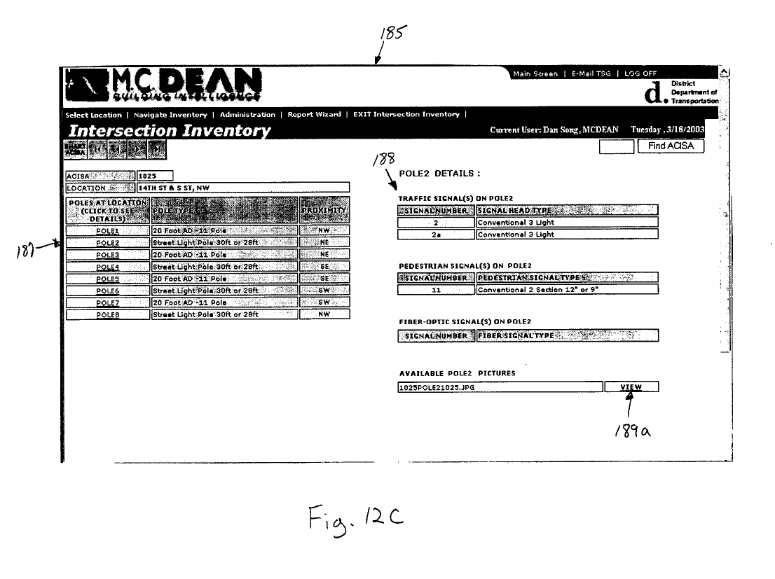

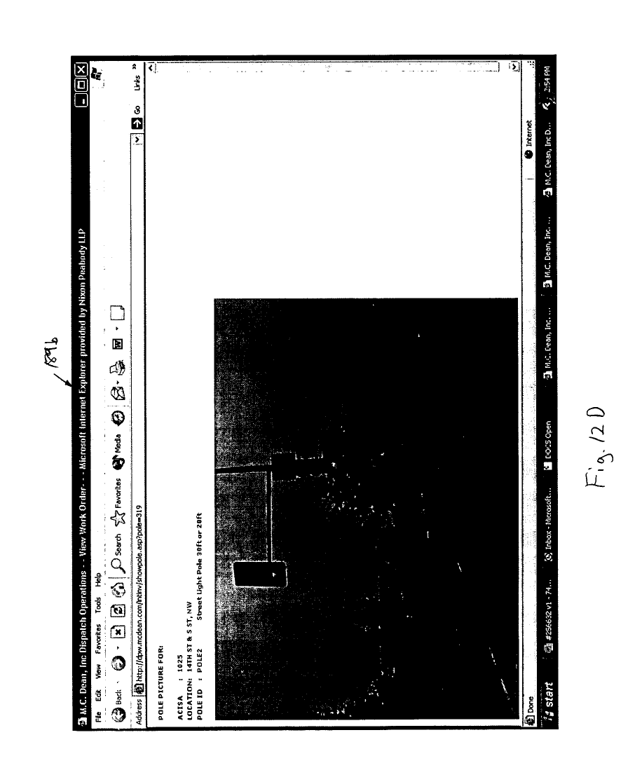

FIG. 12A shows an intersection location screen 181 that is displayed by selecting “Intersection Inventory” 180 from the toolbar 116 on the main page 115 shown in FIG. 4, and further selecting the “Select Location” 186a from the inventory toolbar 183. The inventory toolbar 183 is also provided with “Navigate Inventory” 186b selection, as well as the links “Administration” 160 and “Report Wizard” 170 that provide access to functions and features of the administration and reporting modules of TIMS discussed previously above. Furthermore, the inventory toolbar 183 is further provided with “Exit Intersection Inventory” 186c selection which returns the user of TIMS to the main page 115 shown in FIG. 4.

The intersection location screen 181 as shown in FIG. 12A lists the locations or intersections having transportation devices that is being monitored and/or serviced utilizing TIMS. In this regard, the ACISA number 126 which is a number assigned by the municipality or city to a particular location or intersection, is set forth as a list together with the actual location described using street names. The intersection location screen 181 also allows searching of the desired intersection by entering either the intersection number or the letters of the street name in data fields 182a and clicking on search buttons 182b corresponding to the data fields 182. Additional locations may be accessed by selecting the desired page link 138.

To obtain the actual intersection inventory, the desired intersection is selected by clicking on one of the “Select” links 184. Upon selection of an intersection, an intersection inventory screen 185 as shown in FIG. 12B is displayed which sets forth detailed inventory information associated with the selected intersection. Alternatively, the “Navigate Inventory” 186b from the inventory toolbar 183 may be selected to view the intersection inventory screen 185. The details of the selected intersection or location is provided on the intersection inventory screen 185, as well as the various pole links 187 to which the transportation devices are mounted and their respective pole location. In addition, an “Add New Pole” button 185a may be provided on the intersection inventory screen 185 to allow addition of a new pole as well as the information associated with the transportation devices that are mounted to the new pole. Furthermore, a modification button 185b may be provided to allow modification to any of the existing records regarding the intersection inventory.

As noted, the pole links 187 are implemented as a link in the present embodiment so that when the desired pole is selected, additional detailed information regarding the pole is displayed. For example, FIG. 12C shows the intersection inventory screen 185 when link 187 to “POLE2” is selected. As shown, details associated with POLE2 is shown in itemization list 188 in which the various signals attached to the selected pole is itemized thereby providing an inventory of transportation devices secured to the selected pole. In addition, a picture showing the selected pole is accessed by clicking “VIEW” 189a which brings up window 189b as shown in FIG. 12D which displays information and an actual picture of the selected POLE2 in the selected intersection. The provision of a picture of the selected pole of the intersection allows users of TIMS of the present implementation to verify location of the transportation device requiring service and/or maintenance.

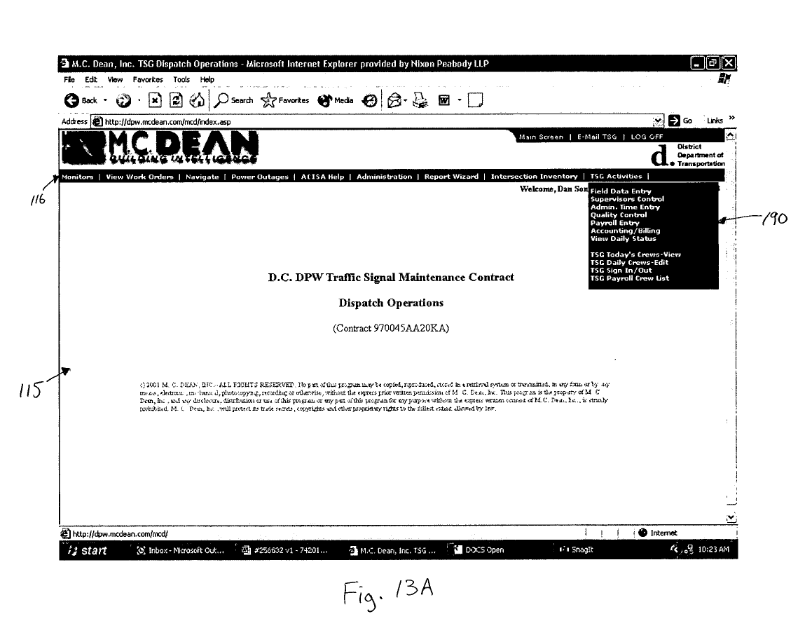

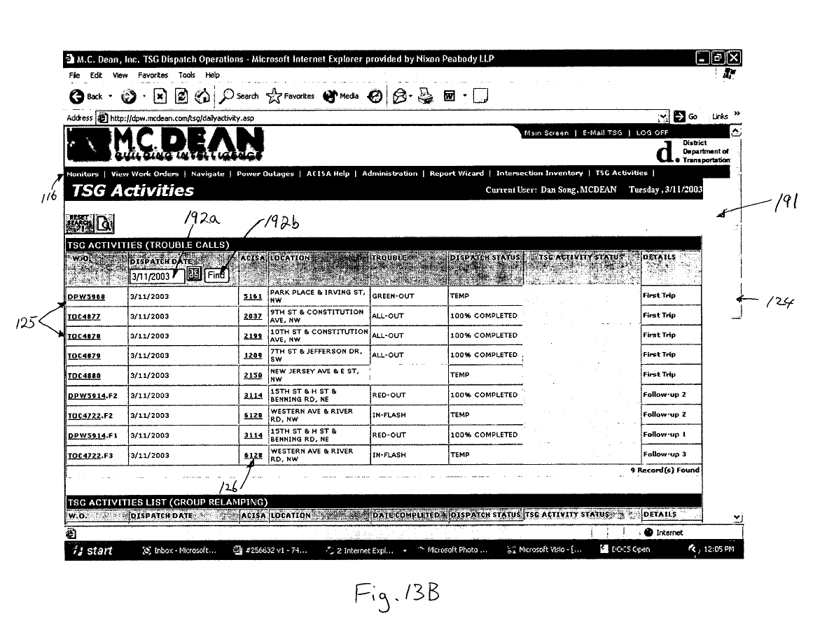

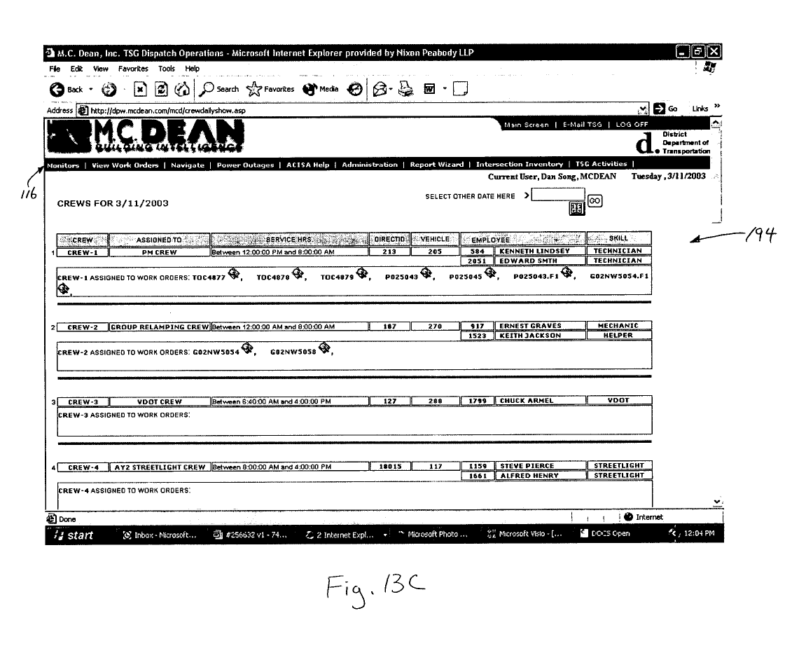

FIG. 13A shows the main page 115 with the “TSG Activities” 190 dropdown menu of toolbar 116 in its expanded form. It should be initially noted that TSG stands for Transportation Systems Group and generally refers to any contractor that may be employed by the municipality or city for servicing the transportation devices. As can be seen by the menu items of the TSG Activities 190 dropdown menu, various administrative features and functions are provided including field data entry, supervisors control, time entry, quality control, payroll entry, and accounting/billing. In this regard, these features are directed to the administrative tasks of managing personnel and are peripherally related to service of a plurality of transportation devices.

FIG. 13B shows activity screen 191 that is displayed upon selection of “View Daily Status” menu item from the TSG Activities 190 dropdown menu. As shown in FIG. 13B, the activity screen 191 lists various activities associated with trouble calls, group relampings, preventive maintenance, fiber optic signals, school flashers, etc. which can be viewed using the scroll bar 124. In particular, for each of these activity lists, the work order number 125, the dispatch date, the ACISA number 126, location, trouble, dispatch status, activity status, and details are shown in the activity screen 191 to allow monitoring of the servicing activities. A specific dispatch date may be searched by entering the desired dispatch date in the field 192a and clicking on the “Find” button 192b.

FIG. 13C shows crew screen 194 that is displayed upon selecting “TSG Today's Crew-View” menu item from the TSG Activities 190 dropdown menu. As shown, a variety of crews and their assigned work orders as well as service hours are provided. This allows effective management of personnel trained to service and maintain the transportation devices of a municipality or city. In this regard, ancillary features such as daily-edit, sign-in/out, and payroll crew list can also be accessed by TSG Activities 190 dropdown menu.

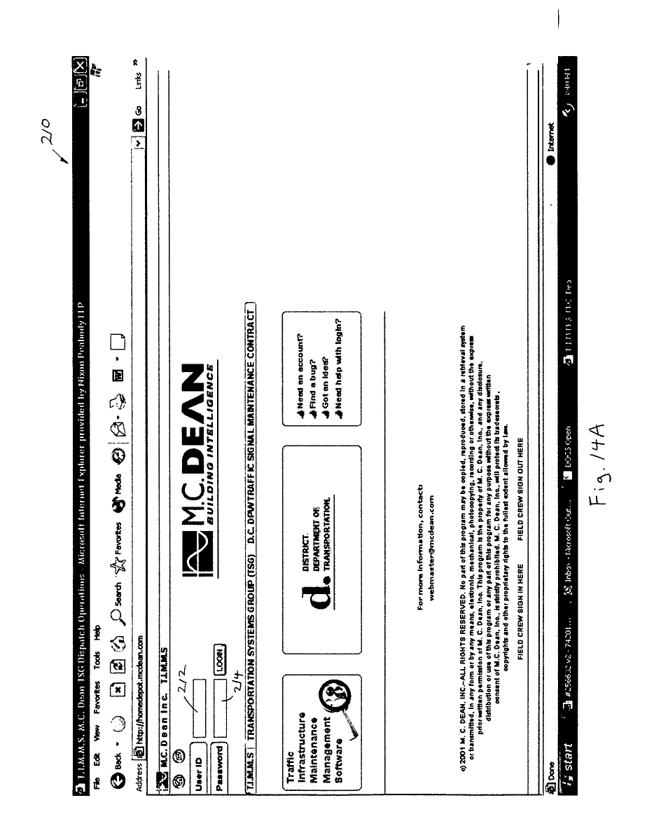

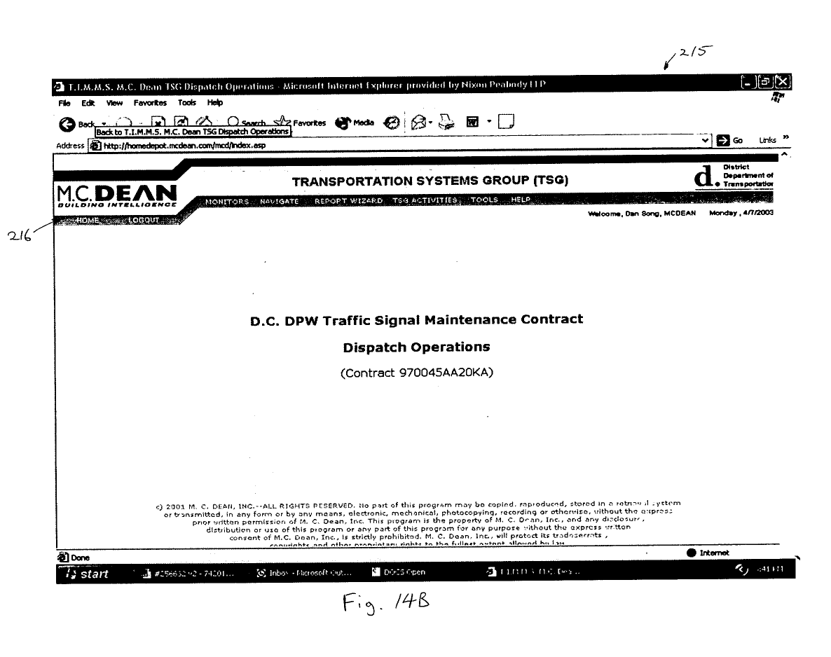

FIG. 14A shows another example of a TIMS interface 210 in accordance with the present invention that is implemented as website http://homedepot.mcdean.com. As previously noted with respect to FIG. 3, whereas the TIMS interface 210 is accessed and shown via a browser program window, the browser program does not form any part of the present invention. As shown in FIG. 14A, the TIMS interface 210 is implemented for the Department of Transportation for Washington, D.C.

The TIMS interface 210 may be used to access the various functions and features of TIMS by entering an authorized user ID and password in the User ID 212 field and Password 214 field. Upon entry of a valid user ID and password, main page 215 shown in FIG. 14B is displayed with toolbar 216 having a plurality of dropdown menus as well as various selections which provide access to the various functions and features of the corresponding modules of TIMS in the manner previously described relative to the implementation of FIG. 4. In this regard, those dropdown menus and selections that are implemented in a substantially the same manner as the implementation of FIG. 4 are not discussed in further detail herein to avoid repetition.

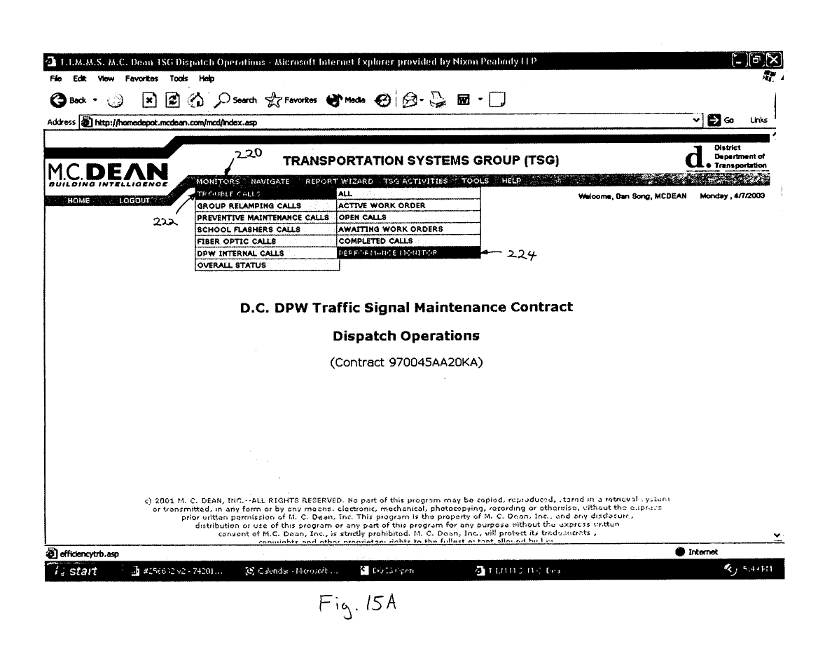

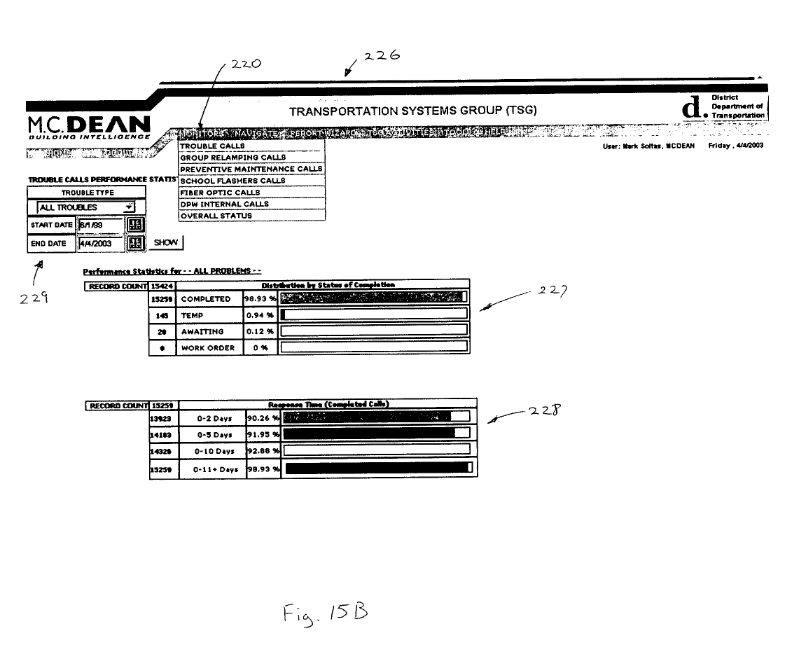

FIG. 15A shows an expanded view of the Monitors 220 dropdown menu that allows the user of TIMS to access the functions and features of the monitoring module. In this regard, FIG. 15A also shows an expanded view of the “Trouble Calls” 222 selection which in turn, also provides various menu selections associated with trouble calls. As can be appreciated, these selections allow display of particular classification of trouble calls. Upon selecting the “Performance Monitor” 224 selection, the performance statistics screen 226 as shown in FIG. 15B is displayed. In the illustrated implementation of the performance statistics screen 226, statistical analysis of the number and percentage of trouble calls that are completed, temporarily being worked on, awaiting parts or action from other third parties, etc. are set forth numerically and visually as a bar graph in the Distribution by Status of Completion display 227. Moreover, the duration of time required to respond to the trouble calls are set forth in the Response Time display 228 as also shown in FIG. 15B.

Other parameters may be used to further narrow the performance information provided in the performance statistics screen 226 by selecting the type of trouble calls being analyzed, and/or by restricting the date parameters via the parameter selector 229 also displayed on the performance statistics screen 226. The information as provided in the performance statistics screen 226 allows the user to monitor the effectiveness of the service being provided by the contractors servicing and maintaining the transportation devices, as well as their responsiveness to trouble calls.

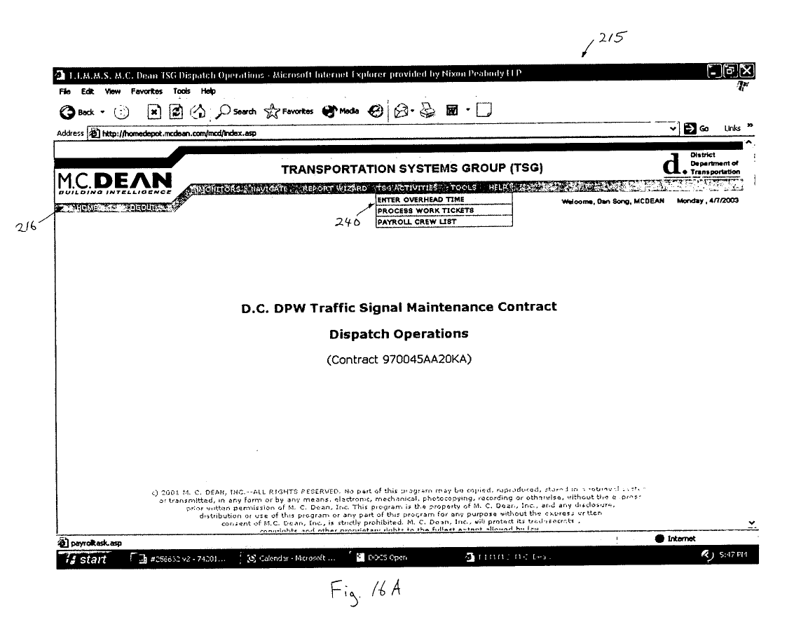

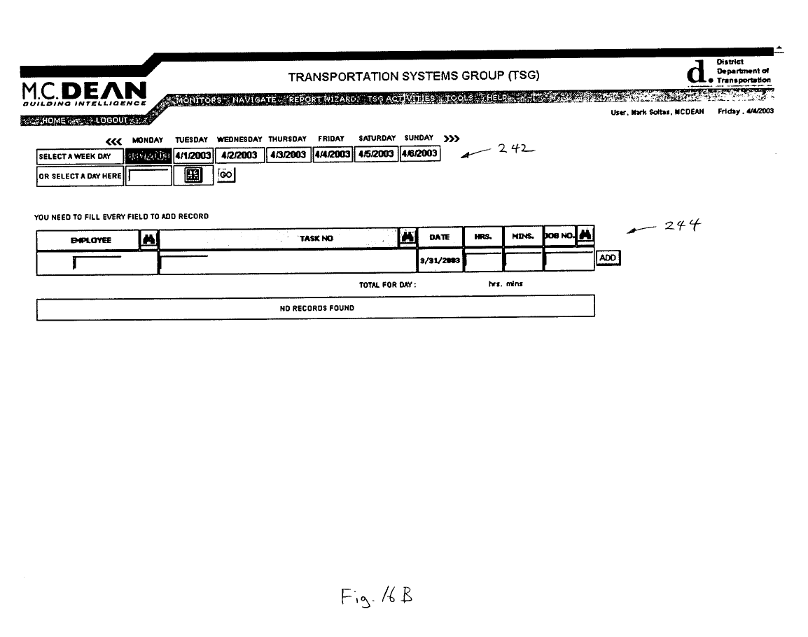

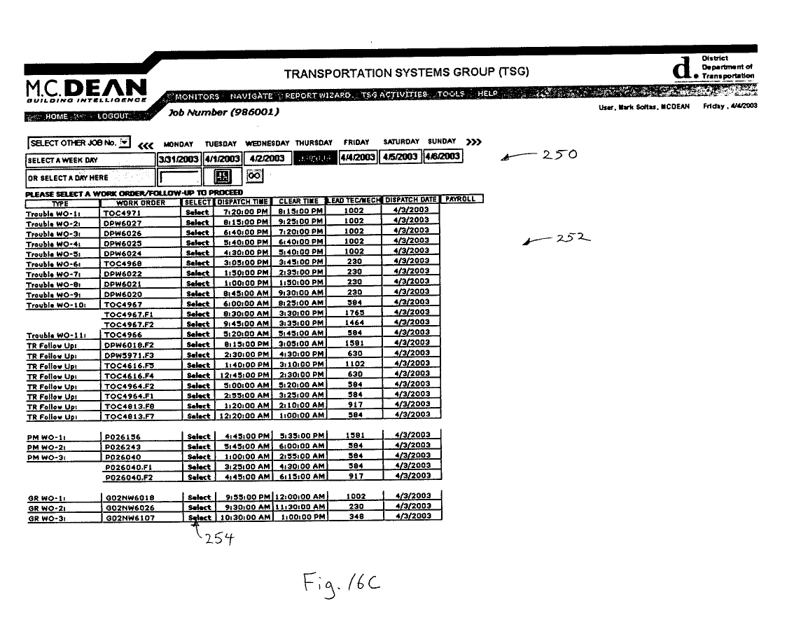

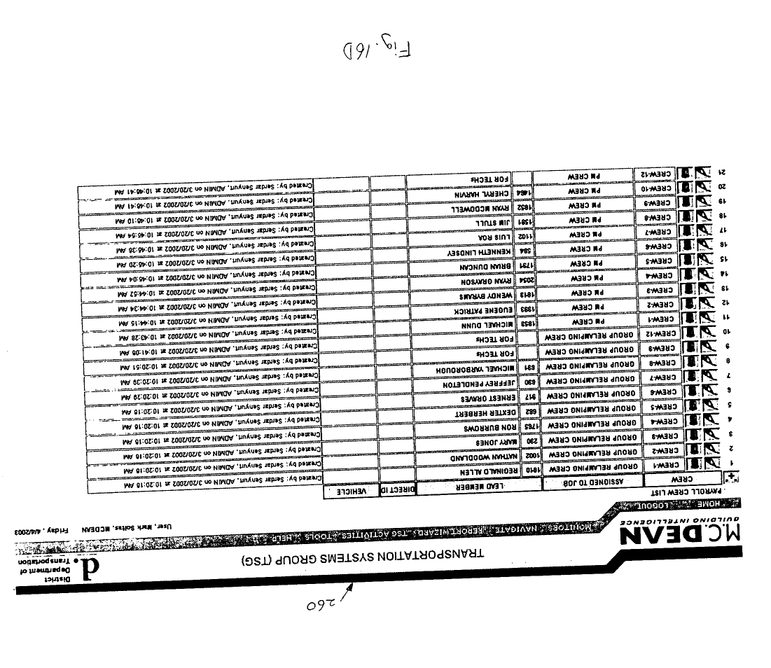

FIG. 16A illustrates an expanded view of the TSG Activities 240 dropdown menu of the toolbar 216 in the main screen 215 in accordance with one implementation that provides access to the activity module of TIMS. Upon selecting the “Enter Overhead Time” selection from the TSG Activities 240 dropdown menu, a date selector 242 as shown in FIG. 16B is displayed which allows the user of TIMS to select the date for which overhead time is to be entered. Upon selection of a particular date, a record entry form 244, as also shown in FIG. 16B, is displayed which allows entry of various field parameters to allow entry of overhead time that indicates miscellaneous work activity identified as nonproductive labor. By monitoring nonproductive labor, an employee's work efficiency can be closely monitored by the administrator.

Referring again to FIG. 16A, upon selecting the “Process Work Tickets” selection of the TSG Activities 240 dropdown menu, a date selector 250 is displayed which allows the user of TIMS to select the date for displaying the work orders associated with the desired date. In this regard, the work order screen 252 as shown in FIG. 16C is displayed which lists all of the work orders associated with the selected date, and various detailed information associated to the selected date. A payroll entry may be inputted by selecting any transportation work order via links 254 for any date selected. Upon selection of the desired work order, the work order as well as the applicable contract pay items can be inputted and/or confirmed for bill processing purposes thereby facilitating the management of payroll and billing.

FIG. 16D shows payroll crew list screen 260 that is displayed upon selection of the “Payroll Crew List” from the TSG Activities 240 dropdown menu of the toolbar 216 of FIG. 16A. The payroll crew list screen 260 lists the various crews and information associated with each crew such as crew leaders who are responsible for field activity documentation and accuracy of such documentation. The editing of the information associated with each of the crews and the members of the crews are facilitated by selection of edit buttons 262 which further allows selection of any individual listed within the payroll and/or crew. The payroll crew list screen 260 also facilitates inspection and/or confirmation of the worker, the work performed, and time expended. As can be appreciated, this feature allows effective management of personnel.

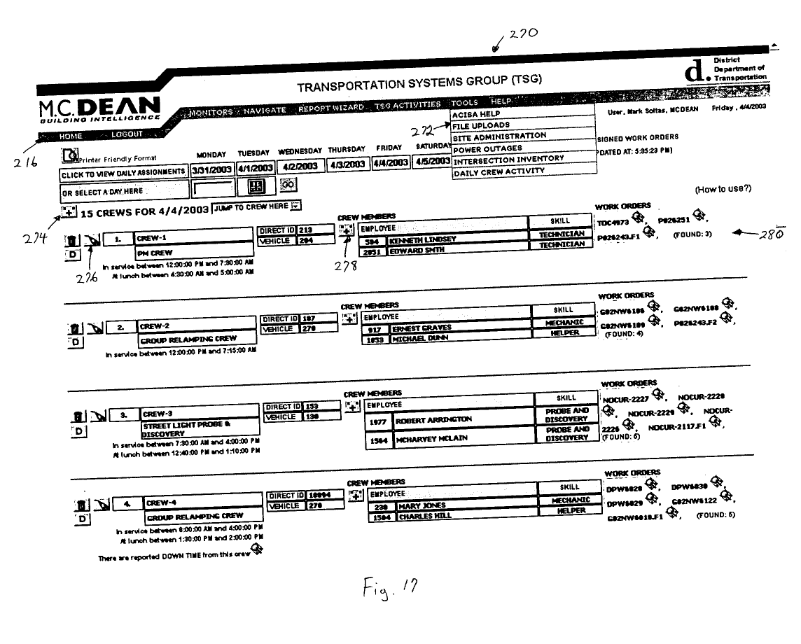

FIG. 17 illustrates an expanded view of an optional Tools 272 dropdown menu which provides menu selections that link to various modules of TIMS to provide the user access thereto. FIG. 17 also shows crew activity screen 270 that is displayed by selecting the “Daily Crew Activity” selection of the Tools 272 dropdown menu which links to the activity module of TIMS. The crew activity screen 270 provides a real-time schedule viewer of current, as well as scheduled activities, with an automated access into payroll system log functions when input is recorded by dispatchers. This enables dispatchers to access information regarding a work order, crew or worker, and/or work performed, while also allowing logging of dispatch arrival, down, and clear times as required for the purpose of tracking personnel work activities.

As shown in FIG. 17, detailed information associated with each of the crews are provided including the crew members. Additional crews may be added by clicking on the “+” button 274. In addition, information regarding each of the crews may be edited by clicking on the edit button 276. Each of the crews members may be displayed as shown and members may be added or deleted from the crew by clicking on the “+” button 278. Moreover, as also shown in FIG. 17, work orders that are assigned to the particular crew is shown in the work orders window 280. These features further facilitate management of personnel that service and maintain the transportation devices.

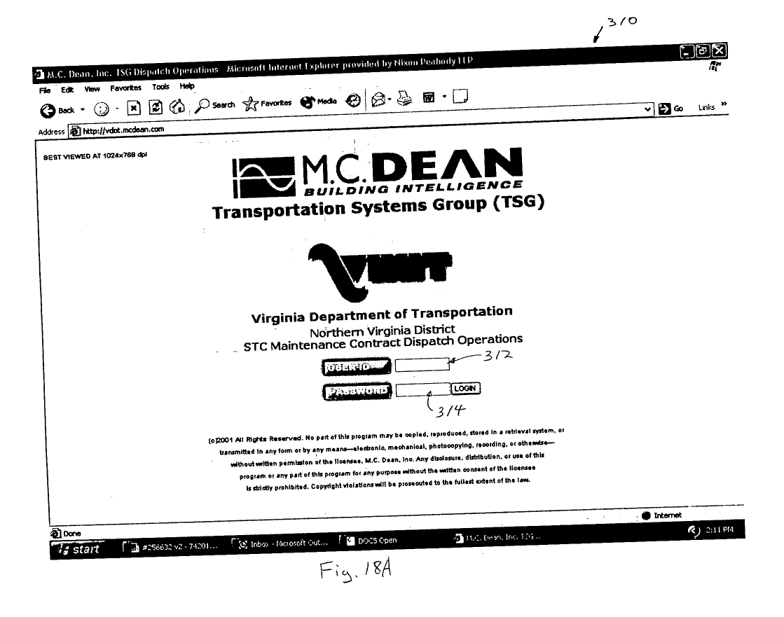

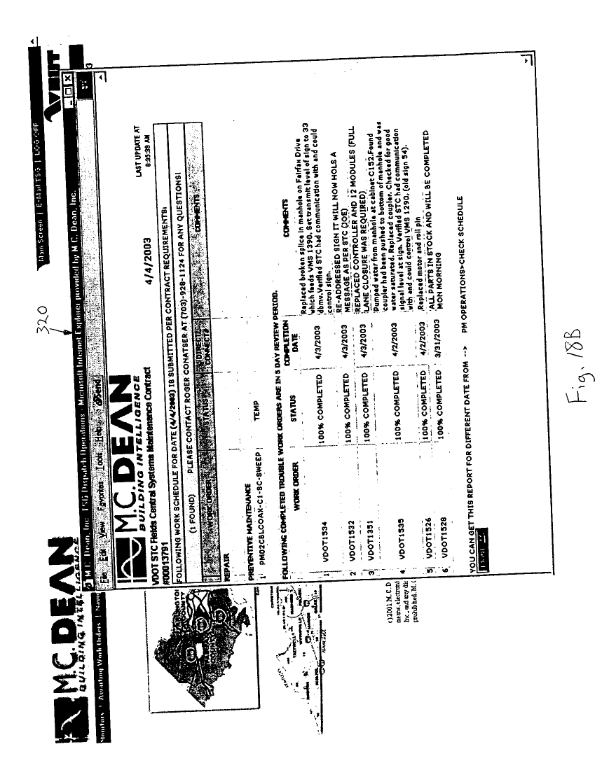

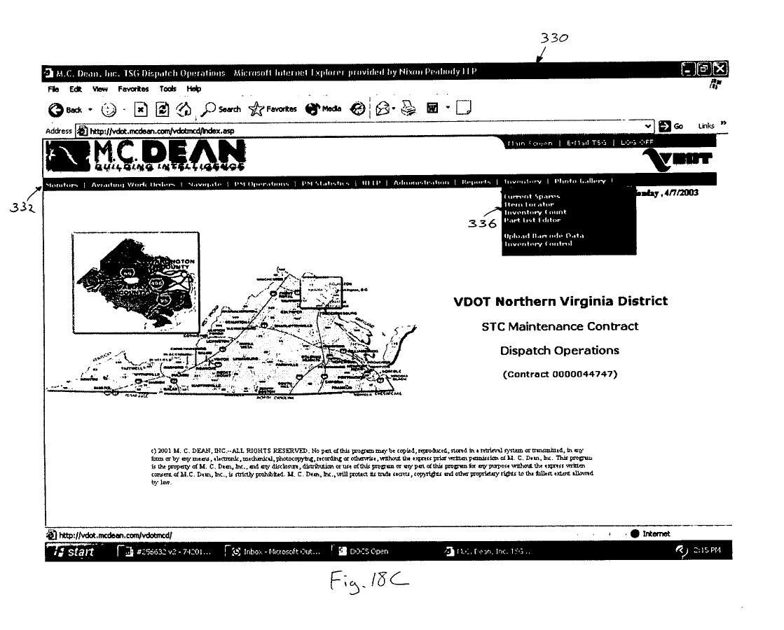

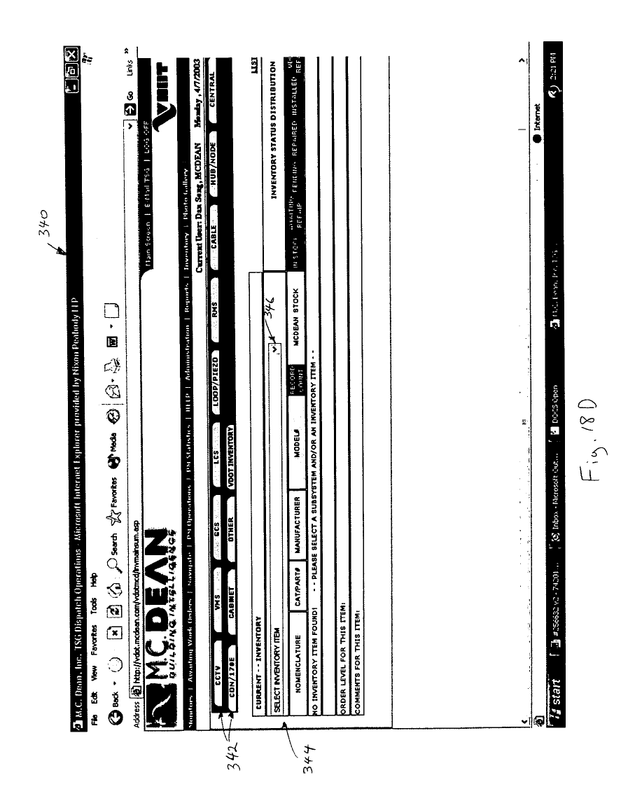

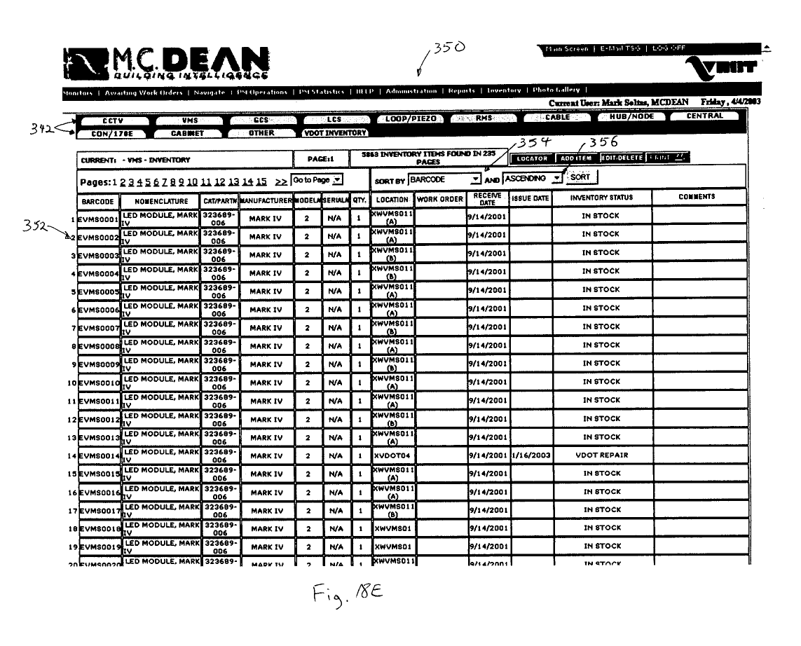

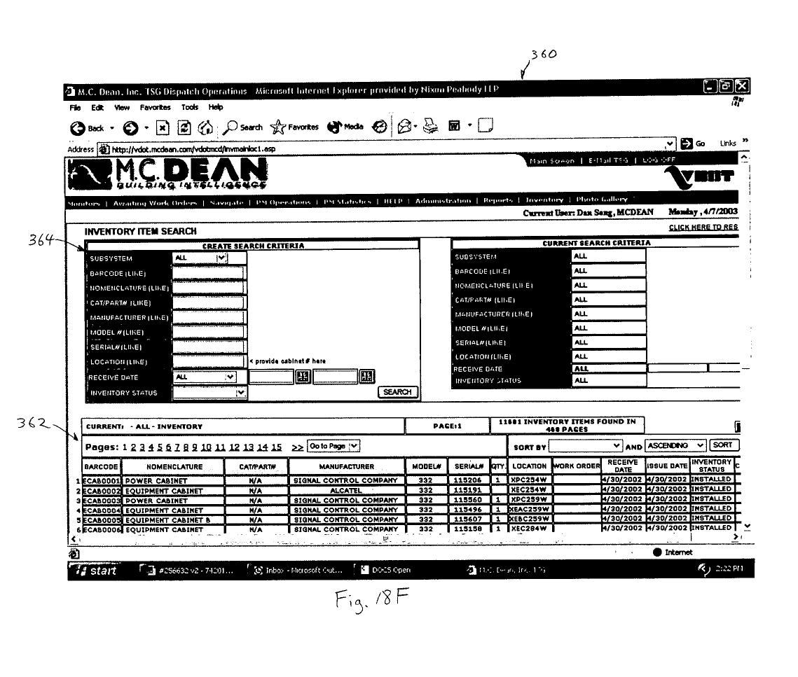

FIG. 18A shows still another example of a TIMS interface 310 in accordance with the present invention implemented as website http://vdot.mcdean.com. The TIMS interface 310 is accessed and shown via a browser program window by logging in by entering the user ID in field 312 and entering a password 314. As shown in FIG. 18A, the TIMS interface 310 is implemented for the Virginia Department of Transportation for the Commonwealth of Virginia.

Upon logging into TIMS via the TIMS interface 310, a pop-up window 320 which sets forth various details and status of recent work orders is displayed as shown in FIG. 18B. Status information associated with various work order activities as determined by routine maintenance requirements, repair work order requirements that are pre-selected by priority, and/or contract time response requirements may be displayed in the pop-up window 320. Such status information may be required by the city or municipality.

The pop-up window 320 of FIG. 18B may be closed or minimized in the conventional manner to allow viewing of the main page 330 shown in FIG. 18C, the main page 330 being provided with toolbar 332 with plurality of dropdown menus and/or selections. The plurality of dropdown menus and/or selections of the toolbar 332 may be implemented in a manner similar to that of the main page 115 shown in FIG. 4 and described above. In this regard, further discussion of the plurality of dropdown menus and/or selections of the toolbar 332 are omitted herein to avoid repetition except the Inventory 336 dropdown menu which is discussed in further detail below.

The Inventory 336 dropdown menu is implemented with a plurality of menu selections that allow access to the functions and features of the inventory module of TIMS as previously described. In particular, the Inventory 336 dropdown menu allows effective monitoring of inventory of components used in the maintenance of transportation devices. Upon the selecting the “Current Spares” selection from the Inventory 336 dropdown menu, an transportation device inventory selection screen 340 is displayed as shown in FIG. 18D which provides a plurality of selectable links 342 which are associated with various transportation devices. In addition, search inventory field 344 may also be provided as shown having a dropdown menu 346 which allows the transportation devices to be selected in an alternative fashion.

Upon selection of the desired transportation devices using either the selectable links 342 or the dropdown menu 346, a transportation device inventory screen is displayed. For example, FIG. 18E shows a transportation device inventory screen 350 that is displayed upon selection of selectable link 342 identified as “VMS” which stands for variable message sign that are utilized on highways and roadways to indicate, for example, road conditions, use restrictions, or the like. Each of the other selectable links 342 are associated with other transportation devices that may be used in the transportation infrastructure.

As shown in the example of FIG. 18E, the generated transportation device list 352 may provide various information associated with the transportation device such as subsystem, nomenclature, barcode number, catalog/part number, manufacturer, model number, serial number, quantity, location, date received and issued, associated work order, inventory status and/or comments, if any. Moreover, sort fields 354 and 356 may be provided as shown to allow facilitated sorting of the generated list. Of course, TIMS of the present implementation also allows generation of lists for the other transportation devices upon selection of a desired selectable link 342 or dropdown menu 346 item.

FIG. 18F shows an inventory item search screen 360 that is displayed upon selecting “Item Locator” from the Inventory 336 dropdown menu shown in FIG. 18C. The inventory item search screen 360 provides an inventory list 362 classified by categories to allow viewing of all types of inventory components used to maintain transportation devices, as well as components acquired under purchase contracts, and components acquired from client and used under contract. In the illustrated implementation, the inventory list 362 sets forth for each component type and specific item, as well as various information such as date received and detailed status for components tracking/disposition. For example, status information for the inventory may be displayed as being awaiting repairs, in stock, installed, on order, repaired, unrepairable, etc. In addition, the inventory list 362 may be focused by entering various search parameters in the search window 364.

Referring again to the Inventory 336 dropdown menu shown in FIG. 18C, the “Inventory Count” selection displays an search inventory field such as that shown in FIG. 18D which allows the retrieval and searching of inventory components and information associated with such components. The “Part List Editor” selection of the Inventory 336 dropdown menu allows insertion, deletion and/or editing of known, and future items for inclusion into the database of TIMS. In this regard, information such as subsystem, nomenclature, catalog/part number, manufacturer, model number, order level, and comments if any, may be inserted, deleted, or otherwise edited. In addition, the “Upload Barcode Data” selection of the Inventory 336 dropdown menu allows uploading of “.csv” extension file types as logged from barcoding devices. Lastly, the “Inventory Control” selection of the Inventory 336 dropdown menu allows updating of field activity and warehouse records for reconciliation and synchronization of records within predetermined time schedule.

As previously noted, the above implementations merely illustrate various examples of how TIMS may be implemented as a website. It should again be noted that TIMS may be implemented in any appropriate manner and should not be limited to the embodiments shown and described.

It should now be evident to one of ordinary skill in the art how the present invention provides an effective system for managing transportation devices of a transportation infrastructure. In particular, it should be evident how TIMS in accordance with the present invention facilitates monitoring, tracking, scheduling, inventorying, and reporting of service for transportation devices such as traffic signal lights, flashing signals, lane signals, pedestrian signals, street lamps, signage lamps, fiber optic signals, etc. As explained above, prior to TIMS of the present invention, no solutions existed for effectively managing a transportation infrastructure of a municipality or city which may have thousands of transportation devices at hundreds of intersections or locations.

In addition, it should also be apparent that the present invention also provides for a method of managing transportation infrastructure. The method includes the steps of storing data associated with the plurality of transportation devices into a database, the data including work orders data with service information regarding the plurality of transportation devices, and location data with information identifying locations of the plurality of transportation devices, searching the data associated with the plurality of transportation devices from the database based on at least one of the work orders data and the location data, and generating a classified listing of the plurality of work orders.

The classified listing may be generated based on status of each of the plurality of work orders, and the plurality of work orders may be classified as being active, open, or complete. Alternatively, the classified listing may be generated based on parties that generated each of the plurality of work orders, and may further include the step of generating a listing of awaiting work orders which are awaiting further action by a third party. Moreover, the method may further include the step of creating new work orders and/or editing existing work orders.

The classified listing may be generated based on the type of service required and/or the type of transportation device. The type of service required may be group relamping and/or preventive maintenance while the type of transportation device may be school flashers and/or fiber optic signals. It should also be evident that the method may further include the step of accessing information regarding scheduled power outages, where the information regarding scheduled power outages includes identification of locations affected. The method may further include the step of searching the database based on the location information associated with the plurality of transportation devices. In this regard, each location may be associated with an intersection identification number.

In other variations of the present invention, the method may further include the step of generating dispatch information and/or generating at least one report with detailed information associated with the plurality of transportation devices. The may further include the step of generating reports based on the type of service required by the plurality of transportation devices, dates of the work orders, and locations of the plurality of transportation devices.

The method may further include the step of generating inventory information associated with the plurality of transportation devices where each location is associated with an intersection identification number, and a selected intersection identification number being searched to generate inventory information associated with the selected intersection identification number. The inventory information may include a list of components of transportation devices at a specific intersection location. The method may also further include the step of listing activities being undertaken by work crews in still another embodiment. The above methods should be evident in view of discussions of FIGS. 1 to 18F above.

While various embodiments in accordance with the present invention have been shown and described, it is understood that the invention is not limited thereto. In particular, whereas examples of the present invention is described above having all of the various modules, other embodiments may be implemented with fewer or additional modules. In addition, whereas a website implemented example of TIMS was described in detail, the present invention may be implemented in any appropriate manner. Thus, the present invention may be changed, modified and further applied by those skilled in the art. Therefore, this invention is not limited to the detail shown and described previously, but also includes all such changes and modifications.

I claim:

1. A transportation infrastructure management system for managing service of transportation infrastructure having a plurality of transportation devices comprising:
a database adapted to store data associated with said plurality of transportation devices, said data including work orders data with service information regarding said plurality of transportation devices, and location data with information identifying locations of said plurality of transportation devices;
a processor connected to said database and adapted to facilitate input of said data into said database, and retrieval of said data from said database; and
a module connected to said processor and adapted to retrieve said data associated with said plurality of transportation devices from said database based on at least one of said work orders data and said location data.

2. The transportation infrastructure management system of claim 1, wherein said module is a monitoring module adapted to generate a classified listing of said work orders based on status of each of-said work orders.

3. The transportation infrastructure management system of claim 2, wherein said work orders are classified as being at least one of active, open, and complete.

4. The transportation infrastructure management system of claim 1, wherein said module is a work order module adapted to generate a classified listing of said work orders, said work orders being classified based on parties that generated each of said work orders.

5. The transportation infrastructure management system of claim 4, wherein said work order module is further adapted to allow viewing of awaiting work orders which are awaiting further action by a third party.

6. The transportation infrastructure management system of claim 4, wherein said work order module is further adapted to allow at least one of creation of new work orders and editing of existing work orders.

7. The transportation infrastructure management system of claim 1, further comprising a navigation module adapted to generate a classified listing of said work orders, said work orders being classified by at least one of type of service required and type of transportation device.

8. The transportation infrastructure management system of claim 7, wherein said type of service required is at least one of group relamping and preventive maintenance.

9. The transportation infrastructure management system of claim 7, wherein said type of transportation device is at least one of school flashers and fiber optic signals.

10. The transportation infrastructure management system of claim 1, further comprising a power module adapted to provide information regarding scheduled power outages.

11. The transportation infrastructure management system of claim 10, wherein said information regarding scheduled power outages includes identification of locations affected.

12. The transportation infrastructure management system of claim 1, further comprising a location identification module adapted to search said database based on said location data identifying location of said plurality of transportation devices.

13. The transportation infrastructure management system of claim 12, wherein each location is associated with an intersection identification number.

14. The transportation infrastructure management system of claim 1, further including an administration module adapted to allow viewing of dispatch information.

15. The transportation infrastructure management system of claim 1, further comprising a reporting module adapted to generate at least one report with detailed information associated with said plurality of transportation devices.

16. The transportation infrastructure management system of claim 15, wherein said reporting module is further adapted to generate at least one report based on at least one of type of service required by said plurality of transportation devices, dates of said work orders, and locations of said plurality of transportation devices.

17. The transportation infrastructure management system of claim 1, further comprising an inventory module adapted to generate inventory information associated with said plurality of transportation devices.

18. The transportation infrastructure management system of claim 17, wherein each location is associated with an intersection identification number, and said inventory module is further adapted to search said database based on a selected intersection identification number, and generate inventory information associated with said selected intersection identification number.

19. The transportation infrastructure management system of claim 17, wherein said inventory information includes a listing of components of transportation devices at a specific intersection location.

20. The transportation infrastructure management system of claim 1, further comprising an activity module adapted to facilitate monitoring of activities being undertaken by work crews.

21. The transportation infrastructure management system of claim 1, wherein said transportation devices include at least one of traffic signal lights, flashing signals, lane signals, pedestrian signals, street lamps, signage lamps, and fiber optic signals.

22. The transportation infrastructure management system of claim 1, wherein said transportation infrastructure management system is connected to a wide area network.

23. The transportation infrastructure management system of claim 22, wherein said transportation infrastructure management system is remotely accessible through said wide area network.

24. The transportation infrastructure management system of claim 23, wherein said wide area network is Internet.

25. The transportation infrastructure management system of claim 24, wherein said transportation infrastructure management system is a website.

26. A method of managing transportation infrastructure having a plurality of transportation devices comprising the steps of:
storing data associated with said plurality of transportation devices into a database, said data including work orders data with service information regarding said plurality of transportation devices, and location data with information identifying locations of said plurality of transportation devices;
searching said data associated with said plurality of transportation devices from said database based on at least one of said work orders data and said location data; and
generating a classified listing of said work orders.

27. The method of claim 26, wherein said classified listing is generated based on status of each of said work orders.

28. The method of claim 27, wherein said work orders are classified as being at least one of active, open, and complete.

29. The method of claim 26, wherein said classified listing is generated based on parties that generated each of said work orders.

30. The method of claim 29, further including the step of generating a listing of awaiting work orders which are awaiting further action by a third party.

31. The method of claim 30, further including the steps of at least one of creating new work orders and editing existing work orders.

32. The method of claim 26, wherein said classified listing is generated based on at least one of type of service required and type of transportation device.

33. The method of claim 32, wherein said type of service required is at least one of group relamping and preventive maintenance.

34. The method of claim 32, wherein said type of transportation device is at least one of school flashers and fiber optic signals.

35. The method of claim 26, further including the step of accessing information regarding scheduled power outages.

36. The method of claim 35, wherein said information regarding scheduled power outages includes identification of locations affected.

37. The method of claim 26, further including the step of searching said database based on said location data identifying locations of said plurality of transportation devices.

38. The method of claim 37, wherein each location is associated with an intersection identification number.

39. The method of claim 26, further including the step of generating dispatch information.

40. The method of claim 26, further including the step of generating at least one report with detailed information associated with said plurality of transportation devices.

41. The method of claim 40, further including the step of generating reports based on at least one of type of service required by said plurality of transportation devices, dates of said work orders, and locations of said plurality of transportation devices.

42. The method of claim 26, further including the step of generating inventory information associated with said plurality of transportation devices.

43. The method of claim 42, wherein each location is associated with an intersection identification number, and said method further includes the steps of searching said database based on a selected intersection identification number, and generating inventory information associated with said selected intersection identification number.

44. The method of claim 42, wherein said inventory information includes a list of components of transportation devices at a specific intersection location.

45. The method of claim 26, further including the step of listing activities being undertaken by work crews.

46. The method of claim 26, wherein said transportation devices include at least one of traffic signal lights, flashing signals, lane signals, pedestrian signals, street lamps, signage lamps, and fiber optic signals.

47. A transportation infrastructure management system for managing servicing of plurality of transportation devices including traffic signal lights and pedestrian signals in a municipality or city, said transportation infrastructure management system comprising:
a database adapted to store data associated with said plurality of transportation devices, said data including work orders data with service information regarding said plurality of transportation devices, and location data with information identifying location of each of said plurality of transportation devices;
a processor connected to said database and adapted to facilitate input of said data into said database, and retrieval of said data from said database;
a monitoring module connected to said processor, said monitoring module being adapted to retrieve said data associated with said plurality of transportation devices, and to generate a classified listing of said work orders;
a location identification module connected to said processor, said location identification module being adapted to search said database based on said location data identifying location of each of said plurality of transportation devices; and
a reporting module adapted to generate at least one report displaying at least one of said classified listing of said work orders, and a listing of said location data identifying location of each of said plurality of transportation devices.
